(19) United States
(12) Patent Application Publication
(10) Pub. No.: US 2010/0304225 A1
(43) Pub. Date: Dec. 2, 2010

(54) ELECTROLYTE FORMULATIONS FOR ENERGY STORAGE DEVICES BASED ON IONIC LIQUIDS

(75) Inventors: Matthias Pascaly, Munster (DE); Armin Modlinger, Kamenz (DE); Martin Schuster, Haltern am See (DE); Roy Van Hal, Koeln (DE); Claus Hilgers, Koeln (DE); Marc Uerdingen, Lohmar (DE)

Correspondence Address: OBLON, SPIVAK, MCCLELLAND MAIER & NEUSTADT, L.L.P., 1940 DUKE STREET, ALEXANDRIA, VA, 22314, US

(73) Assignee: EVONIK DEGUSSA GmbH, Essen (DE)

(21) Appl. No.: 12/670,483

(22) PCT Filed: May 28, 2008
(86) PCT No.: PCT/EP08/56530

§ 371 Date: Jul. 6, 2010

(30) Foreign Application Priority Data
Jul. 23, 2007 (EP) 07112930.8

(51) Int. Cl. H01M 10/0566; H01M 10/056

(52) U.S. Cl. 429/342; 429/188; 429/343; 429/200; 429/207

(57) ABSTRACT

The invention relates to an electrolyte formulation comprising a) an ionic liquid which is electrochemically stable over a range of at least 4.5 V, has a viscosity of less than 300 mPa·s at 20° C. and has a conductivity of at least 1 mS/cm at 20° C., and b) an aprotic, dipolar solvent in an amount of 20 to 60% by volume based on the electrolyte formulation, wherein the conductivity of the electrolyte formulation is greater at least by a factor of 2 than the conductivity of the ionic liquid.

### TECHNICAL FIELD

The present invention relates to liquid electrolyte formulations for energy storage devices, especially lithium ion batteries and double layer capacitors, based on ionic liquids.

### BACKGROUND OF THE INVENTION

Electrolytes in commercial lithium ion batteries comprise a conductive salt, usually LiPF₆, which is dissolved in aprotic organic solvents. The constant increase in ever higher-performance electronic portable systems requires an enormous improvement in the performance of future lithium ion batteries with regard to energy density and lifetime. In present-day liquid electrolyte systems, predominantly readily combustible, organic solvents, for example carboxylic esters or acetonitrile, are used, which can ignite in the event of appropriate stress and can thus lead to the destruction of the battery or, in the most unfavourable case, to the destruction of the equipment. Ionic liquids (ILs) are liquid salts having a melting point below 100° C. The interionic interactions ensure that they have negligibly low vapour pressures and hence are nonflammable or barely flammable. Owing to the ionic character, they have conductivities of about 10⁻⁵ up to 10⁻² S/cm.

Typical cations and anions of ionic liquids are reproduced by the following formulae or structural formulae:

| Cations | Anions |
|---|---|
| 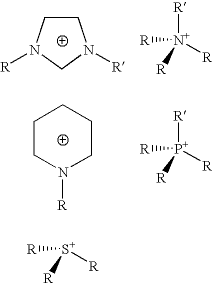 | 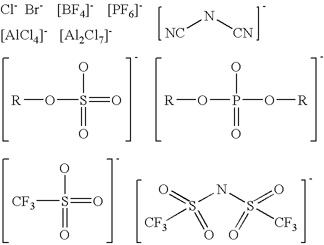 |

Owing to their partly advantageous properties, the substance class of the ionic liquids has been discussed as a novel electrolyte liquid for lithium ion batteries since about the mid-1990s. Use both as a liquid electrolyte and as a conductive polymer is the subject-matter of these studies.

For example, publications US 2003/0165737, U.S. Pat. No. 6,855,457 and EP 1 530 248 describe lithium ion batteries in which electrolytes based on ionic liquids are used. WO 04/082059, in general terms, describes pyrrolidinium-based ionic liquids as a main component of electrolytes. Finally, EP 1 324 358 presents more specific electrolyte formulations for double layer capacitors based on pyrrolidinium ILs.

Since the demands on such electrolyte formulations for ever higher-performance lithium ion batteries are rising, there is still a need for improved electrolytes based on ionic liquids, particular demands being made on the electrochemical stability of the ionic liquid, its viscosity, its conductivity, and with regard to the intended working temperature range. In addition, there should also be a maximum solubility of lithium-containing conductive salts in the particular ionic liquids.

It is an object of the present invention to find electrolyte formulations which are effective within the intended working temperature range of lithium ion batteries or double layer capacitors of −20° C. to 60° C., which have electrochemical stability over a voltage range of at least 4.5 V, which need as little as possible solvent, in order to minimize the risk of inflammability, which have a high conductivity of at least 3 mS/cm, and in which high concentrations of dissolved lithium-containing conductive salts may be possible. The electrolyte solutions should also have a maximum purity at a water content of below 20 ppm.

### DESCRIPTION OF THE INVENTION

The stated object is achieved by an electrolyte formulation comprising a) an ionic liquid which is electrochemically stable over a range of at least 4.5 V, preferably 4.8 V, more preferably 4.9 V, even more preferably 5.0 V and most preferably 5.4 V, has a viscosity of <300 mPa·s, preferably <250 mPa·s, more preferably <200 mPa·s, even more preferably <150 mPa·s, at 20° C. and has a conductivity of at least 1 mS/cm, preferably at least 2 mS/cm, more preferably at least 3 mS/cm, at 20° C., and b) an aprotic, dipolar solvent in an amount of 20 to 60% by volume, preferably 25-55% by volume, more preferably 30-50% by volume, based on the electrolyte formulation, wherein the conductivity of the electrolyte formulation is greater at least by a factor of 2, preferably at least by a factor of 3, more preferably at least by a factor of 4, than the conductivity of the ionic liquid.

In the context of the present invention, the viscosity values are determined using a rheometer (RS 600 model) from Thermo Haake GmbH, Karlsruhe, with a plate/plate measuring apparatus having a diameter of 35 mm. The viscosities are measured for temperatures of −10° C. to 80° C. in steps of 10° C. at shear rates of 100 to 2000 s⁻¹ for the particular temperature. The measurements are recorded with the software RheoWin. The viscosity values stated hereinafter constitute the mean of the values measured for different shear rates at a defined temperature. At temperatures of −10° C. to 80° C., behaviour of a virtually ideal newtonian liquid was detected.

The conductivities of the IL/solvent mixtures were determined in the context of the present invention with a conductivity meter (LF 537 model) from WTW with a 2-electrode glass/platinum test cell. To this end, 5 ml of the IL/conductive salt mixture were filled into a Schlenk tube under a gentle argon stream and kept at a temperature between 22 and 23° C. by means of a water bath. During the measurement, the test cell is immersed into the solution; homogenization is effected by stirring with a magnetic stirrer bar. The solvent is added in 0.2 ml steps via a 2 ml syringe with a cannula. After each addition, homogenization of the solution is awaited, then the corresponding conductivity is measured.

Ionic liquids have a wide structural variability. Owing to their behaviour in the electrical field, only a few anions are suitable for the intended application. For example, organic sulphates and sulphonates or dicyanamides tend either to decompose or to polymerize. Only highly fluorinated anions have the necessary stabilities. In order to identify the individual properties of the ionic liquids used, the structural differences are discussed separately for the anions and cations. The much greater effect on the properties relevant for use as an electrolyte is possessed by the anion. In a comparison of the viscosities of different classes of ionic liquids, taking account of anion stabilities in the electrical field and toxicological aspects, it is found that ionic liquids with the bis(trifluoromethanesulphonyl)imide anion (TFSI anion) have the lowest viscosities and hence high conductivities.

Related to the TFSI melts are the fluorosulphonylamides (N(SO₂F)₂⁻, FSI), which for the most part have even higher conductivities with a comparable electrochemical window. However, a disadvantage of the FSI anions is that they are more difficult to obtain synthetically.

For the compound 1-ethyl-3-methylimidazolium (EMIM) dicyanamide, it is found, by way of example, that the viscosity and/or the conductivity is not the only yardstick. With a viscosity of 17 mPa·s and a conductivity of 27 mS/cm, this compound appears to be of great interest for use in electrolyte formulations. However, the dicyanamides tend to polymerize in an electrical field, and so they cannot be used satisfactorily. The same applies to the class of the thiocyanate anions (SCN⁻).

Dimethide anions (C(SO₂CF₃)₃⁻) have comparable stabilities to the TFSI anions, but lower conductivities are achieved owing to the significantly higher mass of the anion. The trifluoromethanesulphonates (triflates) and trifluoroacetates, in spite of slightly higher viscosities, have astonishingly high conductivities with an electrochemical window in the region of the TSI anions. As well as the class of the TFSI ILs, they are easily obtainable and are therefore suitable for the electrolyte formulations of the present invention.

The so-called classic ionic liquids are understood to mean the BF₄ and PF₆ melts.

These were the first ionic liquids which could be handled under air, and so their use is quite popular to the present day in spite of their tendency to form HF in water. Especially the BF₄ anions are particularly suitable as electrolytes owing to their physicochemical properties. However, it has to be noted that this substance class is very hygroscopic, such that, for example, [EMIM][BF₄] is obtainable only with relatively high water contamination which can be detrimental to the battery performance. Ionic liquids with PF₆ anions have excessively high viscosities as pure substances, and so they can generally be used only in mixtures.

With the hydrogendifluoride anion F(HF)ₙ⁻, it is possible to achieve very low viscosities and high conductivities. Since, though, for example, the ammonium salt has been classified as highly toxic, its use as a base electrolyte should be avoided in this case.

With regard to the suitability of the electrolyte formulations on the basis of their viscosity and conductivity values, the following sequence of known anions can be compiled:

F(HF)ₙ⁻>N(CN)₂⁻>SCN⁻>FS⁻I>C(SO₂CF₃)₃⁻>CF₃SO₃⁻>BF₄⁻>CF₃COO⁻>PF₆⁻

In a preferred embodiment of the invention, the ionic liquid of the electrolyte formulation therefore comprises an anion selected from the group of dihydrogendifluoride, TFSI, FSI, trifluoromethanesulphonate (triflate), thiocyanate, methide, PF₆, trifluoroacetate, perfluorobutanesulphonate (nonaflate) and tetrafluoroborate. It is also possible to use ionic liquid mixtures with the same cation but different anions. Examples include PF₆-containing ionic liquid mixtures, since pure PF₆-containing ionic liquids often have excessively high viscosities, as mentioned above. TFSI, FSI or triflate are the preferred anions in the ionic liquids which are used for the inventive electrolyte formulations.

The cations of the ionic liquids do not determine the viscosity or the conductivity to the same degree as the anions but have a great influence on the electrochemical stability. A compound is considered to be “electrochemically stable” in the context of this invention when it has a current flow of less than 0.1 mA in cyclic voltammetry measurements at a given voltage. The cyclic voltammetry measurements are carried out on an Autolab PGSTAT30 potentiostat from Deutsche Metrohm GmbH & Co. K G, Filderstadt. To record the measurements, the software GPES version 4.9, Eco Chemi B. V. Utrecht, the Netherlands is employed. For the measurement, a three-electrode arrangement in an undivided cell was used. In addition to a platinum working electrode (Metrohm, 6.1204.310), the counterelectrode used was an aluminium foil. The reference electrode used was an Ag/AgCl electrode (Metrohm, 6.0728.010). The measurements were carried out at a scan rate of 10 mV/s under argon at room temperature.

In the context of this invention, the term “electrochemical window” is understood to mean the voltage range within which a compound, especially an ionic liquid, is electrochemically stable.

For example, pyridinium-based ionic liquids have only small electrochemical windows and are therefore often unsuitable for these applications. Phosphonium compounds are generally ruled out owing to their excessively high viscosities. Ammonium compounds likewise have quite high viscosities, although controlled structural modifications can be used to lower these high viscosities. For example, introduction of a hexyl substituent allows the viscosity in [hexyltrimethylammonium][TFSI] to be lowered to 82 mPa·s.

The introduction of functionalized alkyl chains, for example of alkoxyalkyl substituents, can also bring about the lowering of the viscosity and hence an increase in conductivity. One example of this is [diethylmethyl-(2-methoxyethyl)ammonium][TFSI] with a viscosity of approx. 140 mPa·s, a conductivity of 4 mS/cm and an electrochemical window of 5.4 V.

The cyclic ammonium compounds, especially with pyrrolidinium cations, in some cases, exhibit even lower viscosities at high conductivities. All ammonium compounds are notable for large electrochemical windows in the range of 4.5 to 5.9 V. Dimethylimidazolium-based ionic liquids are advantageous owing to their high viscosity and conductivity, but have poorer stabilities than the ammonium compounds.

The meaning of the asymmetry of the structure of the cation becomes clear in particular from the imidazolium-based ionic liquids. For example, [1,3-dimethylimidazolium][BF₄] is a high-viscosity liquid, whereas [1-ethyl-3-methylimidazolium][BF₄] has a low viscosity.

A structural peculiarity of the imidazolium-based ILs is that they have a CH-acidic hydrogen atom in the 0₂ position, which can lead, for example, to carbene formation in the presence of palladium. A similar process can also take place in electrochemical processes. Therefore, C₂-alkylated variants are studied electrochemically for the present invention.

In summary, the following sequence of already known cations can be compiled on the basis of their physicochemical properties:

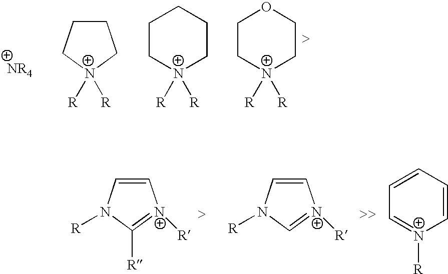

Selective introduction of functionalized substituents allows the performance of the imidazolium cations or of the cyclic ammonium cations to be improved further.

Owing to their physicochemical properties, sulphonium cations are likewise suitable as electrolytes. As compounds suitable for the inventive electrolyte formulations, mention is made here by way of example of the sulphonium-TFSI compounds.

The inventive electrolyte formulation therefore comprises, in a preferred embodiment, an ionic liquid with an organic cation, selected from the group comprising tetraalkylammonium, pyridinium, pyrazolium, pyrrolium, pyrrolinium, piperidinium, pyrrolidinium, imidazolium and sulphonium compounds. Among these organic cations, especially the pyrrolidinium compounds, the imidazolium compounds and the alkylsulphonium compounds are preferred. Additionally preferred are tetraalkylammonium compounds, 1,1-dialkylpyrrolidinium compounds or 1,2,3-trialkyl-imidazolium compounds. As in the case of the above-described anions, it is also possible here to use ionic liquid mixtures with the same anion in each case, but with different cations.

Also conceivable are inventive electrolyte formulations in which ionic liquid mixtures which are composed of different cations and different anions are used.

In the case of the abovementioned cations containing alkyl groups, the alkyl radicals are each independently preferably selected from the group comprising: a) aliphatic straight-chain or branched hydrocarbon radicals which have 1-20 carbon atoms and may additionally have, in the carbon chain, heteroatoms selected from N, S and O, and also unsaturations in the form of one or more double or triple bonds and optionally one or more functional groups which are selected from amino, carboxyl, acyl, hydroxyl groups; or b) cycloaliphatic hydrocarbon radicals having 3 to 20 carbon atoms, where the cyclic radicals may have ring heteroatoms selected from N, S and O and unsaturations in the form of one or more double or triple bonds and optionally one or more functional groups which are selected from amino, carboxyl, acyl, hydroxyl groups.

Organic solvents often have a high dissolution capacity for lithium conductive salts and have already been used for years in IL-free electrolytes for this reason. Undiluted ionic liquids are in most cases only of limited suitability for use as an electrolyte. For instance, the viscosities are relatively high, which generally causes a low base conductivity and additionally complicates the charging of the batteries or capacitors. The cause of this is the formation of large ion clusters in the pure ionic liquids. Dilution with a polar solvent breaks these ion assemblies. At the same time, more ions with a smaller mass and hence a higher mobility are formed. The lower viscosity achieved by the addition increases the mobility and hence the conductivity in addition. In the case of a further addition, ever more ion clusters are broken up until a maximum of conductivity is achieved. Further addition leads to dilution and hence to a decrease in the conductivity. Ionic liquids thus behave like weak electrolytes; the degree of dissociation a would be a measure of the size of the ion assemblies.

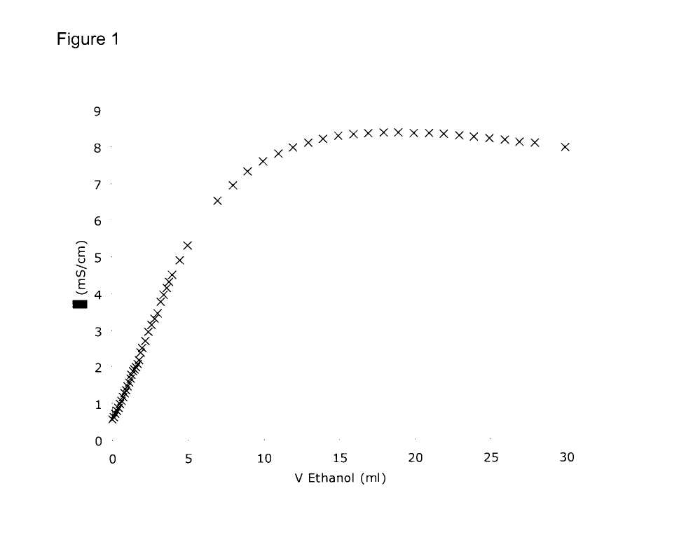

FIG. 1 shows a typical curve for this behaviour, here the dilution of [EMIM][diethylphosphate] with ethanol. As a result of addition of a solvent, in this case, an improvement in the conductivity by a factor of about 15 is observed.

In a preferred embodiment of the invention, the aprotic dipolar solvent of the electrolyte formulation is selected from the group comprising ethylene carbonate, propylene carbonate, dimethyl carbonate, dimethyl sulphoxide, acetone, acetonitrile, dimethylformamide, gamma-butyrolactone, dimethoxyethane, tetrahydrofuran, a dialkyl carbonate or a carboxylic ester.

In a further preferred embodiment of the invention, mixtures of at least two solvents are used. One component should be very polar, preferably with a dielectric constant of >20, which promotes the formation of small ion assemblies. Typical examples of very polar solvents are ethylene carbonate, propylene carbonate, dimethylformamide, acetonitrile or gamma-butyrolactone. As a further solvent of the solvent mixture, a very low-viscosity solvent is then added, preferably with a viscosity of <0.8 mPa·s at room temperature, in order to achieve a further increase in the conductivity by lowering the viscosity. Suitable low-viscosity solvents are, for example, ethers such as dimethoxyethane (DME) and tetrahydrofuran (THF), but also carboxylic esters and dialkyl carbonates, especially dimethyl carbonate (DMC).

A particularly preferred solvent mixture consists of ethylene carbonate and dimethyl carbonate, preferably in a ratio of 50-100:50-0, preferably 60-95:40-5, more preferably 70-90:30-10, most preferably 75-85:25-15, for example 80:20.

With regard to the amount of the solvent present in the inventive formulation, it should be noted that a higher solvent compared to the content of the ionic liquid brings cost advantages, since the ionic liquids are generally much more expensive than solvents. In addition, as shown above, the performance of the electrolyte formulation improves with increasing solvent content up to a certain degree, though the performance with regard to the conductivity of the formulation decreases again in the case of further addition of solvent above a limiting value. With increasing solvent content, further disadvantages can accrue; for instance, the toxicity of the formulation or its flammability can increase when combustible or toxic solvents are used. It has been found for the inventive electrolyte formulations that an amount of solvent of 20-60% by volume, preferably 25-55% by volume, more preferably 30-50% by volume, constitutes the best compromise of maximum conductivity, economic viability, low viscosity, low flammability and toxicity.

To improve the performance, the inventive electrolyte formulations may optionally contain additives. Additives are understood here to mean additions which are added in relatively small amounts, typically up to 5% by weight of the formulation. Since solvents are in some cases used with a significantly higher content, they do not fall into the category of the additives.

For example, in the case of use of graphite electrodes, it is known that they lose ever more layers after several cycles in the course of the reversible intercalation of lithium cations, and hence the lifetime of these graphite electrodes is greatly reduced. One reason for this destruction of the graphite is the additional intercalation of solvent molecules among others. These are decomposed electrochemically in the electrode in the course of the charge-discharge cycles, which destroys the structure of the graphite.

Various additives can prevent these intercalations by formation of a protective layer on the electrode. Provided that the small lithium ions can still migrate through this layer, the electrode can still fulfil its function. Typically, unsaturated or cyclic compounds are used, since they can form a polymer layer. Examples of such additive compounds are acrylonitrile, ethylene sulphite or vinylene carbonate. Very good results are achieved, for example, by addition of 2-15% by volume, for example 5% by volume, of vinylene carbonate.

As becomes clear from the above explanations, some compounds can fulfil a double function in the inventive electrolyte formulation. For instance, the ethylene carbonate described for the solvents can also display positive action in the sense of an additive described here, while, on the other hand, the vinylene carbonate described for the additives also has solvent properties.

In a preferred embodiment, the inventive electrolyte formulation thus additionally contains an additive with a polymerizable functional group. The additive is preferably selected from the group comprising acrylonitrile, ethylene sulphite, propanesultone, an organic carbonate, preferably ethylene carbonate, vinylene carbonate, vinylethylene carbonate or fluoroethylene carbonate, and sulphonates. It is also possible for mixtures of the aforementioned additives to be present in the inventive formulation.

The amount of the solvent and optionally additive in the inventive formulation is preferably selected such that the formulation has a flashpoint of more than 150° C., preferably more than 180° C. and more preferably more than 200° C.

In preferred embodiments of the inventive electrolyte formulation, it additionally comprises one or more conductive salts. In the inventive electrolyte formulations, preference is given to using conductive salts which are selected from the group comprising lithium bisborooxalate (LiBOB), LiTFSI, LiClO₄, LiBF₄, lithium triflate and LiPF₆.

The conductive salts are used typically in the concentration range of 0.1 to 1.5 mol/l, preferably 0.3 to 1.2 mol/l and more preferably 0.5 to 1 mol/l.

For particular applications, a conductive salt need not necessarily be present in the inventive electrolyte formulation. For instance, it has been found that, in the case of electrolytic double layer capacitors (EDLCs), conductive salts are not necessary. This is because it has been found that, surprisingly, in the case of addition of conductive salt in the case of alkoxy-substituted pyrrolidinium ILs, a considerably greater decrease in the conductivity takes place than in the case of the pure alkyl-substituted compounds. Since, however, the alkoxy-substituted pyrrolidinium ILs have a high initial conductivity without conductive salt compared to, for example, alkyl-substituted pyrrolidinium ILs, the ILs with alkoxy-substituted cations are advantageous in applications in which the use of conductive salt is to be or can be dispensed with, for example in the case of double layer capacitors.

In a particular embodiment of the inventive electrolyte formulation, the ionic liquid is therefore a 1-alkoxyalkyl-1-alkylpyrrolidinium compound, preferably with TFSI or FSI as the anion, in which case the formulation does not contain a conductive salt.

In addition, it has been found that the solubility of conductive salts, especially of LiBOB and lithium triflate, in the particular ionic liquids is very different. Especially in the triflate compounds, for example in the pyrrolidinium triflate [Py₁₄][OTf], LiBOB, LiTFSI and lithium triflate exhibit good solubilities, while LiBOB, LiTFSI and lithium triflate do not dissolve in a significant amount in the TFSI-based ionic liquids.

In a further particular embodiment of the inventive electrolyte formulation, the ionic liquid is therefore a triflate compound, preferably a 1,1-dialkylpyrrolidinium triflate, and the conductive salt used in the formulation is LiBOB, LiTFSI or lithium triflate.

The results of extensive studies are described hereinafter, in which especially the influence of the anions and of the cations of the ionic liquid in the electrolyte formulation, the influence of the solvent, the amount of solvent, and the influence of the amount and type of the conductive salt used have been studied.

1. Ionic Liquids Studied

First, the 7 ILs listed in Table 1 are characterized as pure substances with regard to their electrochemical stability and their viscosity. Subsequently, the change in the viscosity as a result of the addition of different solvents and conductive salts is determined. The best possible combination comprising ionic liquid, Li salt, organic solvent and additive is thus determined.

TABLE 1
ILs studied with literature values

| | | Cond. |
|---|---|---|
| IL | Structure | [ms/cm] |
| [ET3S][TFSI] | 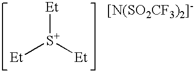 | 6.9 |
| [Py₁₄]FFSI] | 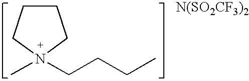 | 2.6 |
| [Py₁₄][OTf] | 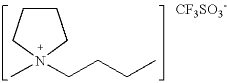 | n. d. |
| [BMIM][OTf] | 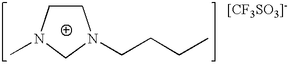 | 2.9 |
| [EdiMIM][TFSI] | 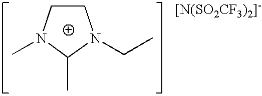 | 3.7 |
| [EMIM][TFSI] | 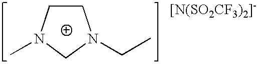 | 8.6 |
| [EMIM][BF₄] | 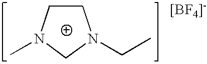 | 14.1 |

Owing to the high electrochemical stabilities of pyrrolidinium-based ILs, [Py14][TFSI] appears to be a promising IL for the application to be studied. However, the comparable imidazolium and sulphonium ILs have much higher conductivities. If the stability of the sulphonium or of the C2-protected imidazole to be studied is above that of the [EMIM] cation, these systems would be preferable for the further application studies. Until then, the [EMIM][TFSI] system, which has been extensively studied in the literature, should serve as a reference point.

2. Characterization of the ILs

Based on the selection made, which is reproduced in Table 1, the ionic liquids were assessed according to their properties. Owing to the high electrochemical stabilities, known from the literature, of the cyclic ammonium compounds and especially pyrrolidinium-based ILs, these should be considered preferred. To verify the assumption made, a basis data set of physicochemical data was determined. To this end, the so-called catalogue qualities were purified further, such that they are available for the measurements in highly pure quality, as shown in Table 2. Apart from [EMIM][BF₄], all products can be provided in outstanding purity. [EMIM][BF₄] cannot be dried further without accepting a further increase in the fluoride value owing to the thermal instability of the BF₄ anion in the presence of water traces. The compound was dried down to a Karl-Fischer value of 414 ppm and then contains 1067 ppm of free fluoride. This constitutes a technically viable compromise. All other 6 compounds contain, apart from residues of free amine, not more than max. 50 ppm of cumulated secondary components such as water and total halide, including fluoride.

TABLE 2
Purities of the ILs studied

| | | Purity | H₂O- | | Residual |
|---|---|---|---|---|---|
| | | (HPLC/NMR | content | Fluoride | halide |
| IL | Structure | assay) | [ppm] | [ppm] | [ppm] |
| [ET3S][TFSI] | 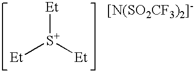 | >98% | 12 | — | — |
| [Py₁₄][TFSI] | 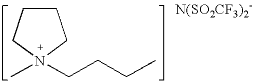 | >98% | 16 | — | 22 |
| [Py₁₄][OTf] | 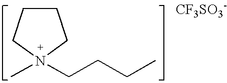 | >98% | 22 | — | — |
| [BMIM][OTf] | 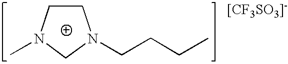 | >99% | 42 | — | — |
| [EdiMIM][TFSI] | 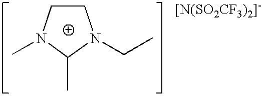 | >99% | 9 | — | 12 |
| [EMIM][TFSI] | 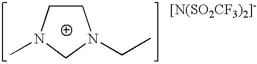 | >99% | 10 | — | 6 |
| [EMIM][BF₄] | 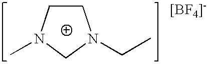 | >99% | 414 | 1067 | 234 |

A ″-″ in Table 2 indicates a value below the detection limit of 5 ppm.

In the literature, the purities are often not reported clearly, even though impurities can be a cause of reduced electrochemical stabilities, changed conductivities, etc. Unlike many literature values, in the present case, the physicochemical data measured and reported are correlated with the corresponding purities.

3. Physicochemical Values of the ILs

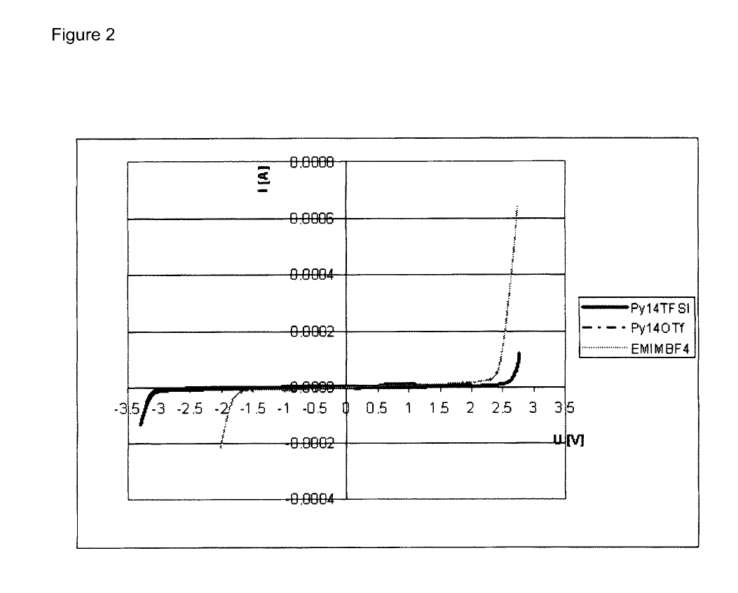

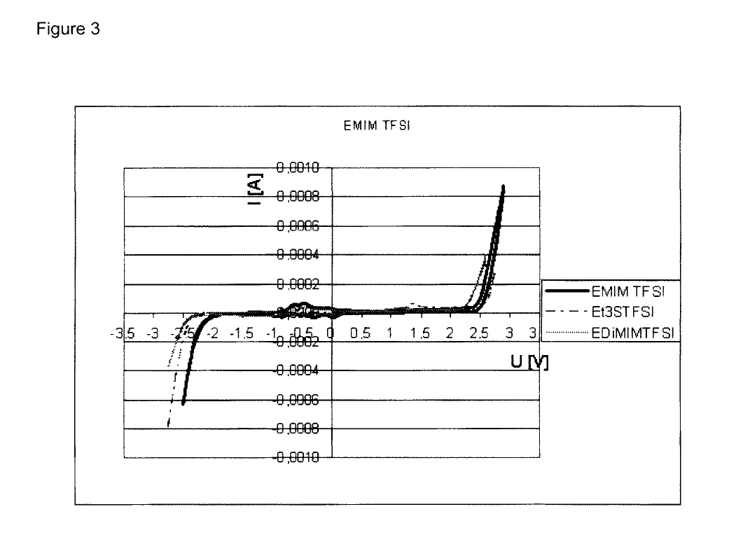

The cyclic voltammograms shown in FIGS. 2 and 3 show the electrochemical stability. These were measured with a potentiostat from METROHM with the electrode configuration of Pt against Al with the Ag/AgCl reference electrode. It was known from the literature that the pyrrolidinium cation is one of the most electrochemically stable. N,N-Butylmethylpyrrolidinium bis(trifluoromethanesulphonyl)imide ([Py14][TFSI]) and N,N-butylmethylpyrrolidinium trifluoromethanesulphonate ([Py14][OTf]), at 6.0 V, have the largest electrochemical windows of the ILs studied. The small difference of the electrochemical windows of the two pyrrolidinium compounds is attributable to the anode potential of the particular anions. Compared to the already very well characterized EMIM cations, the EDiMIM protected in the C-2 position has a much higher stability in the cathodic range. The window is a total of 4.9 V compared to 4.8 V of [EMIM][TFSI]. Extension of the alkyl chain on the imidazole also allows a slightly higher stability to be achieved. The disadvantage of introducing further substituents or longer substituents is the increase in the viscosity and hence also the lowering of the conductivity. Triethylsulphonium bis(trifluoromethanesulphonyl)imide ([ET3S][TFSI] has an electrochemical window of 5.0 V and is therefore more stable than the disubstituted imidazoles, but does not reach the stabilities of the ammonium compounds.

FIG. 2 shows the cyclic voltammograms of [Py14][TFSI], [Py14][OTf] and [EMIM][13F₄].

FIG. 3 shows the cyclic voltammograms of [EMIM][TFSI], [Et3S][TFSI] and [EDiMIM][TFSI].

The smallest electrochemical windows are possessed by the disubstituted imidazolium cations. Owing to the quite high water values, [EMIM][BF₄] declines in the cathodic region compared to [EMIM][TFSI], and, in terms of quality, is not suitable as an electrolyte material. Therefore, these ILs will not be discussed any further hereinafter. [EMIM][TFSI], which is known from the literature and has been one of the best studied for lithium ion batteries, has a window of 4.8 V. If only the electrochemical stability is used as the basis for the decision criterion, the electrolytes should preferably comprise cyclic ammonium compounds. For an optimal electrolyte, however, not only the stability but a maximum conductivity is important.

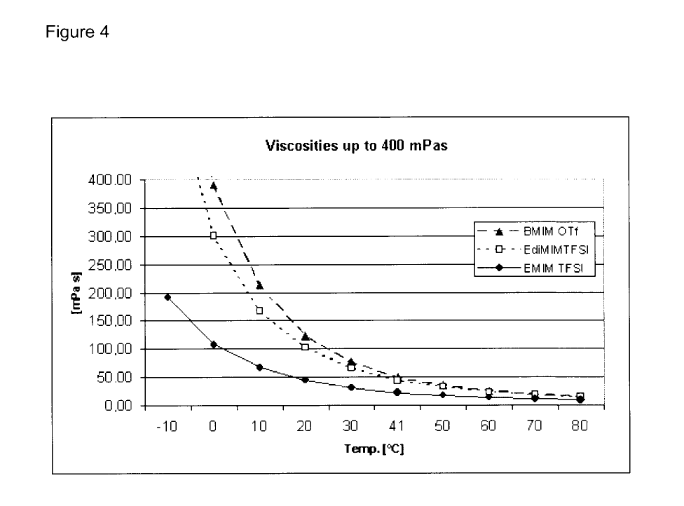

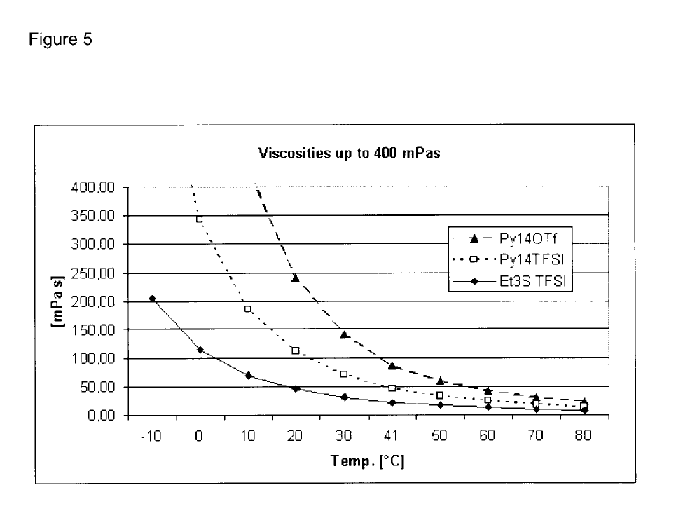

The comparison of the viscosities measured is plotted in FIGS. 4 and 5. As a result of the addition of low-viscosity solvents, the conductivity can be increased under some circumstances. In terms of trend, it can be seen that the electrochemically more stable systems of pyrrolidinium and trisubstituted imidazolium cations have the lowest conductivities and correspondingly highest viscosities.

FIG. 4 shows the comparison of the viscosities in the temperature range of −10 to 80° C.; see also “Table for FIG. 4” in the appendix.

FIG. 5 shows the comparison of the viscosity in the temperature range of −10 to 80° C.; see also “Table for FIG. 5” in the appendix.

The IL [ET3S][TFSI] has a low viscosity and a high conductivity of 6.02 mS/cm, which is the third highest of the selected systems while being one of the most electrochemically stable. [ET3S][TFSI] as well as [Py₁₄][TFSI] is therefore considered as preferred hereinafter in the electrolyte formulations.

The highest conductivities of 8.17 mS/cm and 9.28 mS/cm can be achieved with the disubstituted imidazolium cations with comparable viscosity to the sulphonium compounds. However, as stated above, they do not achieve the necessary electrochemical windows. Table 3 summarizes the physicochemical values of the selected pure ILs.

From this, it becomes clear that it would be of interest to lower the viscosity of the electrochemically stable pyrrolidinium compounds or of the trisubstituted imidazolium compounds by synthetic modification of the cation to give new ILs and thus to further crucially improve the property profile.

TABLE 3
ILs studied

| | | | | Electro- | |
|---|---|---|---|---|---|
| | | | Viscosity | chem. | |
| | | | [mPa•s], | window | Conductivity |
| IL | Structure | Purity | 20° C. | [V] | [mS/cm] |
| [ET3S][TFSI] | 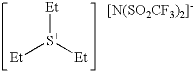 | >98% | 46.1 | 5.0 | 6.02 |
| [Py₁₄][TFSI] | 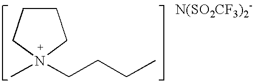 | >98% | 111.8 | 6.0 | 2.47 |
| [Py₁₄][OTf] | 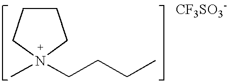 | >98% | 240.4 | 6.0 | 1.65 |
| [BMIM][OTf] | 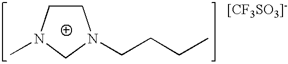 | >99% | 123.1 | 5.0 | 2.62 |
| [EdiMIM][TFSI] | 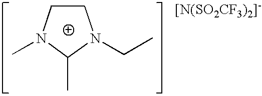 | >99% | 102.3 | 4.9 | 3.40 |
| [EMIM][TFSI] | 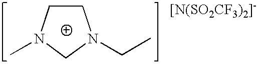 | >99% | 44.9 | 4.8 | 8.17 |

4. Novel Ionic Cation Structures

Based on the comprehensive studies, it becomes clear that, with regard to the electrochemical stability of the cation, ammonium, sulphonium, phosphonium are preferable over the aromatic imidazolium and pyridinium. Taking account of the physicochemical properties, especially of the viscosity and of the directly dependent conductivity, phosphonium compounds are ruled out. The modified structures therefore build on pyrrolidinium, imidazolium and sulphonium.

As a result of the introduction of alkoxyalkyl substituents on the cation, a viscosity-lowering effect and hence an increase in conductivity can be observed. For instance, the compound [diethylmethyl-(2-methoxyethyl)ammonium][TFSI] has values of approx. 140 mPa·s, 4 mS/cm and an electrochemical window of 5.9 V. When the corresponding cyclic aromatic or aliphatic nitrogen compounds are modified, the corresponding alkoxy-substituted IL cations depicted below are obtained:

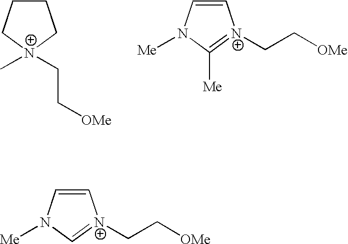

5. Synthesis of the Alkoxy-Substituted ILs

Alkylation of the corresponding amine compound with 2-methoxyethyl chloride allows the correspondingly substituted imidazolium compounds or pyrrolidinium compounds to be obtained in moderate to very good yields. The figure which follows shows the yields:

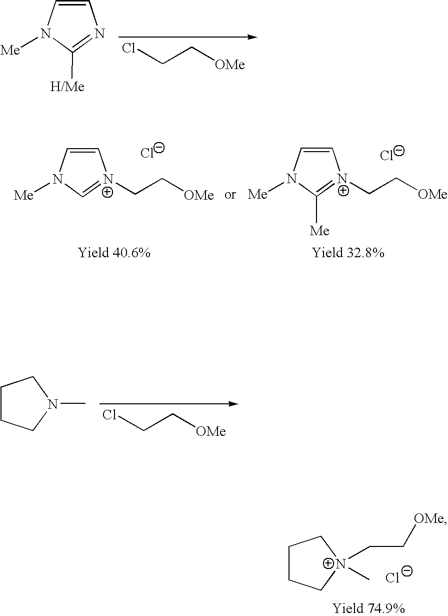

Anion exchange (see diagram below) allows various ILs to be prepared. In order to prepare a high-purity compound for electrochemical applications, it is vital that the resulting ionic liquid forms two phases with water, in order that the salt burden which forms can be removed by extraction even on the industrial scale.

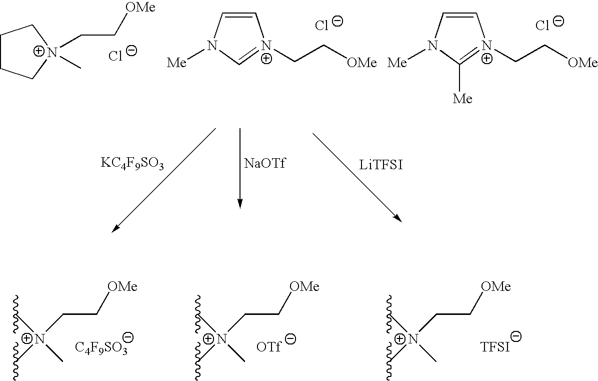

In addition to the electrochemically very interesting triflate (OTf) and TFSI anions which have already been described, nonafluorobutanesulphonate (nonaflate) was also introduced. From three different chlorides, nine novel ILs for different characterizations should thus be formed. However, the influence of the methoxy group had the effect of strong hydrophilization of the products, such that some of the triflates were obtainable only in very poor yields of 10%. The nonaflate compounds were obtained with 50% loss, caused by the high cross-solubility in the water phase. The most hydrophobic anion, TFSI, could be introduced with a good yield of greater than 73% in all cases. All results achieved are compiled in Table 4.

When the overal yield over the two-stage synthesis is considered, it becomes clear that especially the synthesis of [(MeOE)MePyrr][TFSI] is currently possible in an industrially viable manner. However, it should be considered that the individual reaction steps have not been optimized and skillful reaction control can achieve better results. Therefore, all substances obtained in a sufficient amount—apart from the triflates—were characterized physicochemically.

TABLE 4
Yield of the synthesis of the alkoxy-substituted ILs

| | | Yield 2nd | Overall |
|---|---|---|---|
| IL | Structure | stage [%] | yield [%] |
| [(MeOE)MePyrr][OTf] | 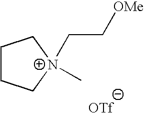 | 10.4 | 7.8 |
| [(MeOE)MePyrr][nonaflate] | 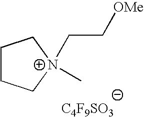 | 49.9 | 37.4 |
| [(MeOE)MePyrr][TFSI] | 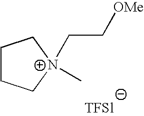 | 77.5 | 58.0 |
| [(MeOE)MIM][OTf] | 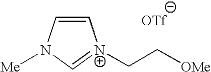 | 0.2 | 0.1 |
| [(MeOE)MIM][nonaflate] | 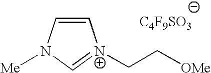 | 47.2 | 19.2 |
| [(MeOE)MIM][TFSI] | 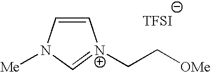 | 76.5 | 31.1 |
| [(MeOE)DiMIM][OTf] | 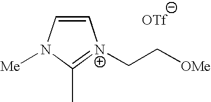 | 2.5 | 0.8 |
| [(MeOE)DiMIM][nonaflate] | 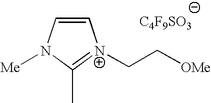 | 71.8 | 23.6 |
| [(MeOE)DiMIM][TFSI] | 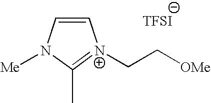 | 73.4 | 24.1 |

6. Physicochemical Values of the Alkoxy-Substituted ILs

The alkoxy-substituted ILs from section 5 have been studied for their viscosity, conductivity and electrochemical stability. The triflates were not analyzed owing to the excessively low yields. Nor were [(MeOE)MePyrr][nonaflate] and [(MeOE)MIM][nonaflate] studied, since they were in solid form at room temperature and, accordingly, high viscosities and low conductivities are to be expected, such that they are unsuitable for use as an electrolyte.

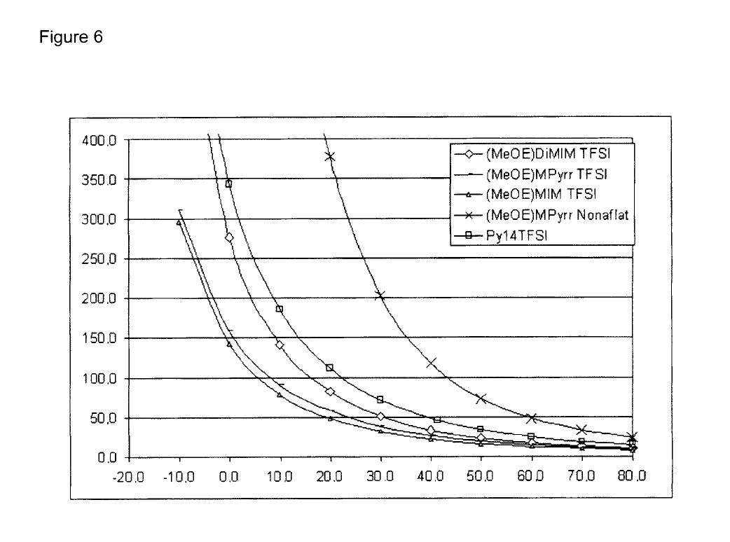

FIG. 6 shows the measured viscosities of alkoxy-substituted ILs and Py14TFSI in the temperature range of −10° C. to 80° C.; see also “Table for FIG. 6” in the appendix.

As a result of the introduction of the methoxy unit, astonishingly low viscosities for the particular base structure can be achieved. For instance, [(MeOE)MPyrr][TFSI] and [(MeOE)MIM][TFSI] have a viscosity of 58.3 mPa·s and 48.2 mPa·s, which are already very low viscosities for pure ionic liquids. One of the best-known low-viscosity ILs is [EMIM][TFSI], which is within the same region at 44.9 mPa·s. Compared to the butyl substituent, the viscosities were halved or reduced by a quarter.

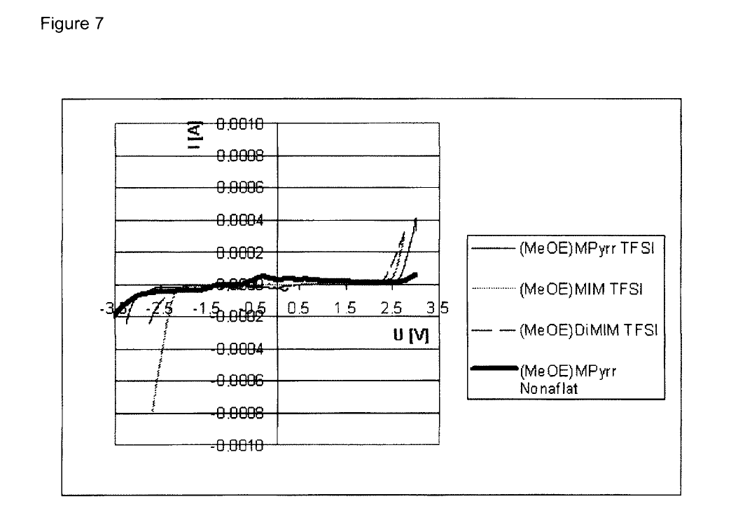

In addition to the low viscosity and associated high intrinsic conductivity, the electrochemical stability is important for the application. The cyclic voltammograms shown in FIG. 7 make it clear that the methoxyethyl-substituted pyrrolidinium compounds, in analogy to the alkyl-substituted compounds, are the most electrochemically stable.

FIG. 7 shows cyclic voltammograms of the alkoxy-substituted ILs.

For instance, [(MeOE)MPyrr][TFSI] has a window of 5.9 V. The increased stability of [(MeOE)MPyrr][nonaflate] suggested from the measurement might be explained by delays caused by the increased viscosity. Somewhat low stabilities are in turn possessed by the 1,2,3-trialkylimidazolium cations, but these are somewhat more stable than the C-2 unprotected imidazolium cations. In terms of electrochemical stability, the alkoxy-substituted ILs are comparable to the alkyl-substituted analogues.

Therefore, the cyclic ammonium systems, the pyrrolidinium compounds, especially the alkoxypyrrolidinium compounds, taking account of the low viscosities, which causes high conductivities, are particularly suitable for use as an electrolyte material.

7. Ionic Liquid Admixed with Conductive Salt

Proceeding from [Py₁₄][TFSI], which is available in electrochemical purities of greater than 99%, this compound was admixed with LiPF₆, LiTFSI, LiBF₄, LiOTf and LiBOB. The second system selected was the compound [Et3S][TFSI] which has to date not been characterized to a high degree. A concentration of 0.75 mol/l based on the ionic liquid was established, and the conductivity of the solution was measured by means of the glass-platinum conductivity electrode from METTLER-TOLEDO (type 980-K197120/1m/2x-27.4). It was found that the conductive salts were all sparingly soluble in [Py₁₄][TFSI] in the concentration of 0.75 mol/l, and so formulations were made up and analyzed only for the most soluble salt LiTFSI in this concentration.

For all conductive salts, the concentration of 0.5 mol/l was then employed. In

[Py₁₄][TFSI], LiBOB does not dissolve at all in the stirred system even over 24 h, and settles out completely as sediment. Just like LiPF₆, LiBF₄ is sparingly soluble. In addition to the readily soluble LiTFSI, it was possible to use LiOTf as a suspension, which is present as a clear formulation from an addition of 6% by weight of dimethoxyethane or 14% by weight of gamma-butyrolactone.

The comparison of the concentration of 0.75 and 0.5 mol/l made up for the [Py₁₄][TFSI]/LiTFSI formulation shows that the difference in the conductivity can be observed but is not significant. It is found that higher conductivities are achieved with mixtures of the pure ionic liquid admixed with gamma-butyrolactone or DMSO than the formulations made up with conductive salt, owing to the viscosity-increasing effect. The comparison of the analogous formulation with 0.5 mol/l compared to 0.75 mol/l of LiTFSI shows that the 0.5 molar conductive salt formulation, in terms of trend, is 0.3 to 0.4 mS/cm more conductive compared to the 0.75 molar formulation. For instance, the [Py₁₄][TFSI]/0.5 molar LiTFSI, compared to [Py₁₄][TFSI]/0.75 molar LiTFSI, has conductivities of 12.54 and 12.16 mS/cm on addition of 8 ml of gamma-butyrolactone.

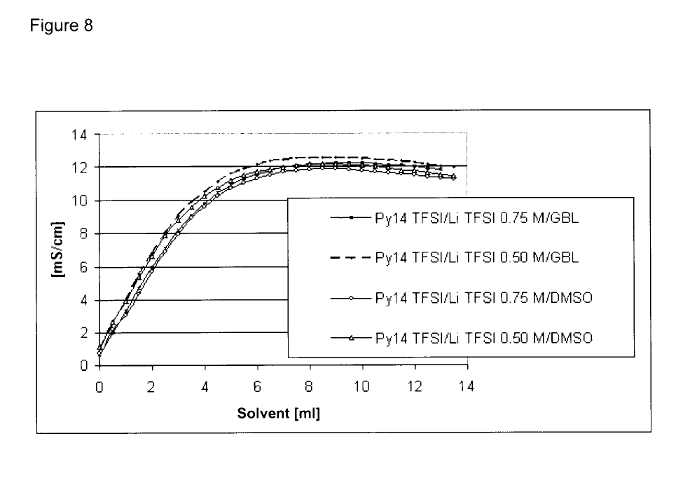

FIG. 8 shows the comparison of the conductive salt concentration of 0.5 relative to 0.75 molar; see also “Table for FIG. 8” in the appendix.

Therefore, for the other selected ILs, mixture series with 0.5 M solutions of the Li conductive salts were made up and it was tested which conductive salts are the best suited to the particular IL. FIG. 8 depicts the mixtures. The systems used in addition to [Py₁₄][TFSI] later are discussed individually; the further systems are also listed for the sake of completeness.

In [Et₃S][TFSI], LiTFSI dissolves completely, but LiBF₄, LiOTf and LiPF₆ only partly; LiBOB forms a sparingly soluble sediment.

In contrast to [Py₁₄][TFSI], surprisingly many conductive salts dissolve in [Py₁₄][OTf] only through the exchange of the anion. It is the only IL in this study series in which LiBOB dissolves completely. LiTFSI, LiBOB and LiOTf form clear solutions at concentration 0.5 M, and LiPF₆ and LiBF₄ are present in partly dissolved form. Owing to the outstanding dissolution properties of [Py₁₄][OTf], this compound is of great interest as a pure electrolyte solution or as a solubilizer for the conductive salts in other electrolytes.

In [(MeOE)MPyrr][TFSI], apart from LiTFSI, only LiBF₄ dissolves completely. LiPF₆ and LiOTf are partly dissolved, and LiBOB again occurs as a solid. Unfortunately, [(MeOE)MPyrr][OTf] was not available in a sufficient amount to consider the anion effect compared to the alkylpyrrolidinium compounds in the same manner. However, it is obvious that [(MeOE)MPyrr][TFSI] has comparable dissolution properties to [Py₁₄][TFSI].

In a particular embodiment of the invention, the ionic liquid is therefore [Py₁₄][TFSI] or [(MeOE)MPyrr][TFSI], and the formulation contains LiTFSI or LiOTf as the conductive salt, preference being given to LiTFSI being present as the conductive salt in a concentration of less than 0.75 mol/l, preferably less than 0.7 mol/l, more preferably less than 0.6 mol/l, based on the ionic liquid.

8. Electrolytes Based on [Py₁₄][TFSI]

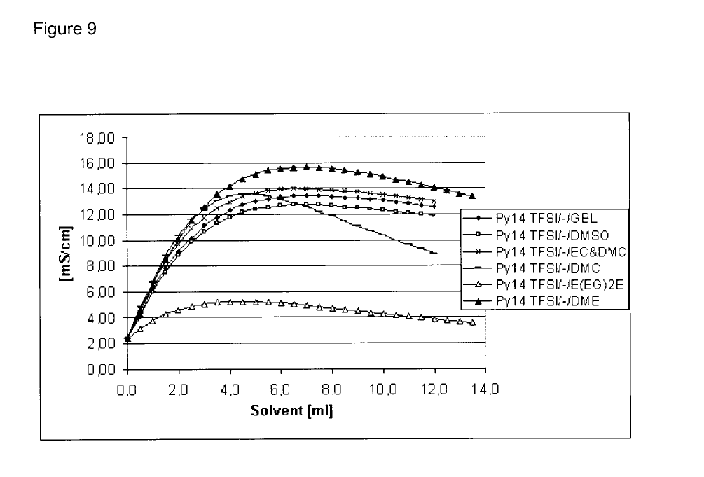

Pure [Py₁₄][TFSI], and also with 0.5 molar LiTFSI and LiOTf was made up and admixed with different contents of polar solvents, addition of 0 to 13.5 ml. The polar solvents used were gamma-butyrolactone (GBL), DMSO, ethylene carbonate (EC), dimethyl carbonate (DMC), dimethoxyethane (DME) and diethylene glycol diethyl ether (E(EG)2E). These solutions were tested for their conductivity. The results obtained for the pure ILs admixed with solvents are reproduced in FIG. 9.

FIG. 9 shows the conductivities of [Py₁₄][TFSI] formulations; see also “Table for FIG. 9” in the appendix.

The use of diethylene glycol diethyl ether (this is of interest in particular as a low-viscosity and non-toxic solvent with a high flashpoint) leads to a significantly poorer conductivity even of the pure IL, such that the use in further formulations cannot be considered to be viable. Pure DMC has a high conductivity increase. Thus, at an equivalent volume ratio, the maximum conductivity of 13.5 mS/cm is already achieved. However, the maximum achieved falls off rapidly compared to the other solvents, such that the dilution range is achieved rapidly before all ion assemblies have broken up. The cause might be an excessively low polarity of the solvent, such that the viscosity effect predominates. The majority of the polar solvents studied achieve the plateau value of the conductivity from a volume ratio of 1:1.2 to 1:1.6. This remains constant up to a ratio of 1:2 before the conductivity decreases as a result of the dilution effect.

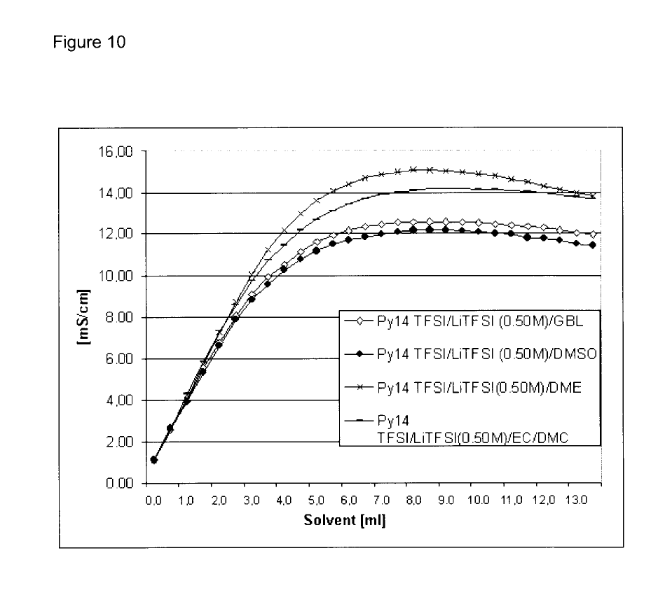

According to the polarity of the solvent used, the ion assemblies are broken up to different degrees, such that the conductivity increase may be more marked. FIG. 10 reproduces the most conductive combinations with LiTFSI salt.

FIG. 10 shows the conductivities of [Py₁₄][TFSI]/LiTFS formulations; see also “Table for FIG. 10” in the appendix.

Surprisingly, the combination of [Py₁₄][TFSI]/LiTFSI with DME exhibits the highest conductivity increase by the factor of 13.5 to 15.09 mS/cm, even though the polarity of DME is lower than that of all other solvents studied. The long-lasting plateau value also confirms this. Pure [Py₁₄][TFSI] behaves analogously to DME. Only owing to the lower starting viscosity is the maximum value of 15.66 mS/cm (factor of 6.4) attained more rapidly.

With the EC/DMC (70:30 v/v) combination, conductivities of 14.18 mS/cm can be achieved. Compared to the first two, gamma-butyrolactone at 12.54 mS/cm and DMSO at 11.91 already decline significantly.

With regard to the possible combustibility of the electrolyte, it would be desirable if it were not to contain more than 30% organic solvent. In order to achieve maximum conductivity values, though, all [Py₁₄][TFSI]/LiTFSI formulations studied contain 50 to 60% solvent. If the 30% mark is assumed as the solubility limit and the conductivities there are considered, the difference between the formulations is not so signficant. DME and EC/DMC (70:30 v/v) have identical values of 7.33 mS/cm and GBL is 6.8 mS/cm. At 30% solvent addition, the starting conductivity has a stronger effect, i.e. the higher the starting conductivity or the lower the viscosity of the formulation without solvent addition, the higher the conductivities that can be achieved in the non-ideal range as a result of higher ion mobility.

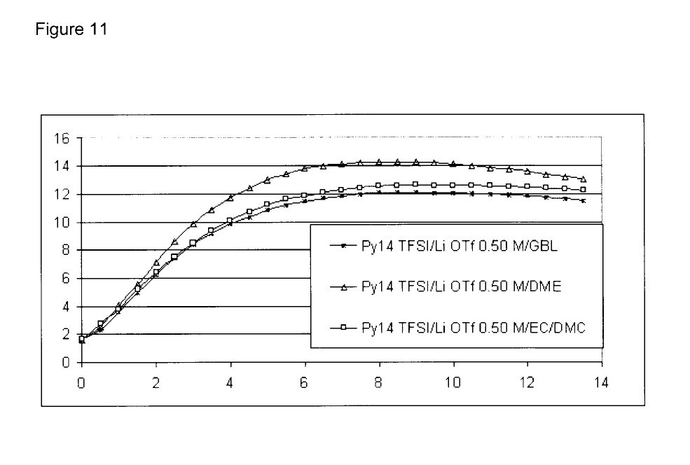

In addition to the LiTFSI salts, suspensions comprising LiOTf were also studied. FIG. 11 reproduces the conductivities of the formulation comprising 0.5 molar LiOTf solutions with DME and EC/DMC (70:30 v/v), and also GBL.

FIG. 11 shows the conductivities of [Py₁₄][TFSI]/LiOTf formulations; see also “Table for FIG. 11” in the appendix.

In analogy to the results obtained with LiTFSI, the highest conductivity of 14.25 mS/cm arises for the [Py₁₄][TFSI]/LiOTf formulation with DME. With EC/DMC (70:30 v/v), only slightly lower maximum conductivities of 12.62 mS/cm can be obtained. For GBL, the curve profile is flatter and the maximum values, at 12.07 mS/cm, are well below those of DME.

9. Electrolytes Based on [Py₁₄][OTf]

Even though [Py₁₄][OTf] has quite a high viscosity of 111.8 mPa·s (20° C.), this IL was studied further, since it can firstly be prepared on the basis of a cost structure of economic interest and it is secondly the only one of the ILs studied that has an outstanding solubility for LiBOB. The high viscosity is also found in the measured conductivity of 1.7 mS/cm without solvent addition. However, as a result of the addition of EC/DMC (70:30 v/v), conductivities even 1.5 mS/cm higher can be achieved than in the [Py₁₄][TFSI]/EC/DMC (70:30 v/v) system. However, up to two equivalents of EC/DMC (70:30 v/v) have to be added for this purpose.

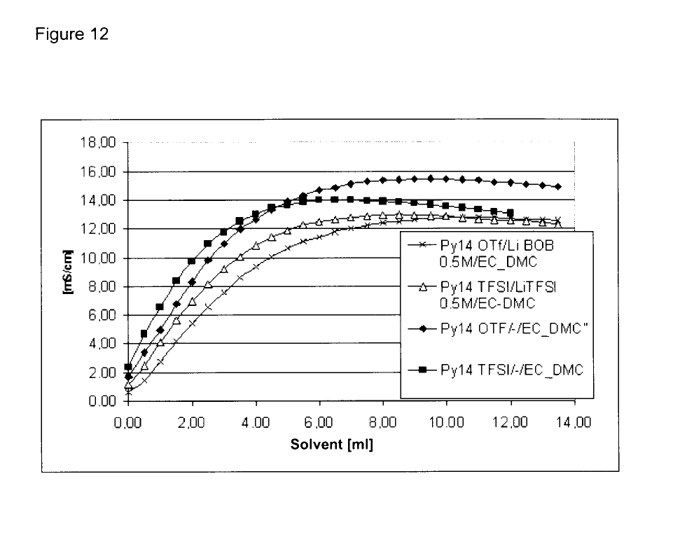

FIG. 12 shows conductivities of [Py₁₄][OTf] formulations compared to [Py14][TFSI] formulations; see also “Table for FIG. 12” in the appendix.

With addition of LiBOB as a conductive salt, the viscosity effect increases, but, in spite of low starting conductivity, the values of [Py₁₄d[TFSI]/LiTFSI can be achieved and even exceeded at high solvent content.

In a particular embodiment of the invention, the ionic liquid is therefore [Py₁₄][OTf], the formulation contains at least 25% by volume, preferably at least 45% by volume, of EC/DMC, preferably in a ratio in the range of 60-100 zu 40-0, as the solvent.

10. Electrolytes Based on [(MeOE)MPy][TFSI]

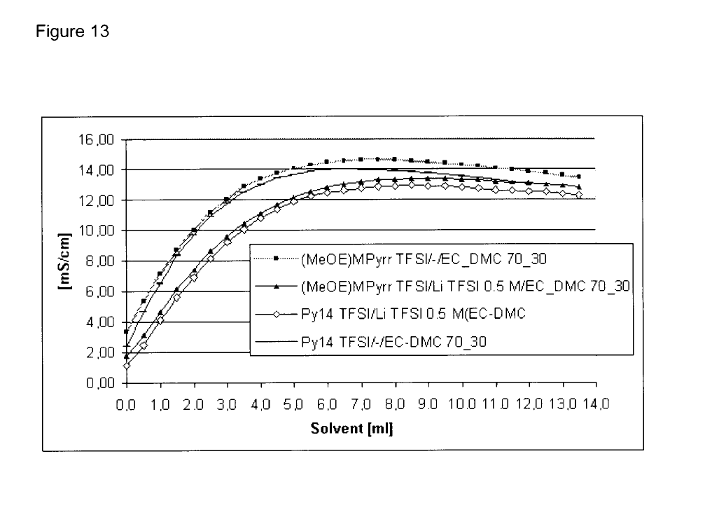

The starting conductivity of the pure IL [(MeOE)MPy][TFSI] is 3.39 mS/cm and is increased by 1 mS/cm compared to the alkyl variant [Py14][TFSI]. In FIG. 13, the conductivity profile in the case of addition of EC/DMC (70:30 v/v) with and without addition of conductive salt is reproduced.

FIG. 13 shows the conductivities of [(MeOE)MPy][TFSI] formulations; see also “Table for FIG. 13” in the appendix.

Astonishingly, the conductivity decrease on addition of LiTFSI conductive salt in the case of [(MeOE)MPy][TFSI] is 0.5 mS/cm more marked than in the case of [Py₁₄][TFSI], such that the effect achieved as a result of the viscosity decrease in the formulation comprising conductive salt does not occur as expected. The profile of the conductivity corresponds to that already discussed in FIG. 10 for the [Py₁₄][TFSI] compound. However, the values achieved are increased by 0.5 mS/cm. The maximum value is achieved at 13.36 mS/cm. It is thus found that further functionalization of the side chains allows the conductivity to be increased.

On the basis of the results of chapters 8 to 10, in particular embodiments of the invention, the ionic liquid is a pyrrolidinium compound, preferably [Py₁₄][TFSI] or [(MeOE)MePyrr][TFSI], in which case the formulation contains DMC, DME or EC/DMC, preferably in a ratio in the range of 60-100 to 40-0, as the solvent.

11. Electrolytes Based on [Et₃S][TFSI]

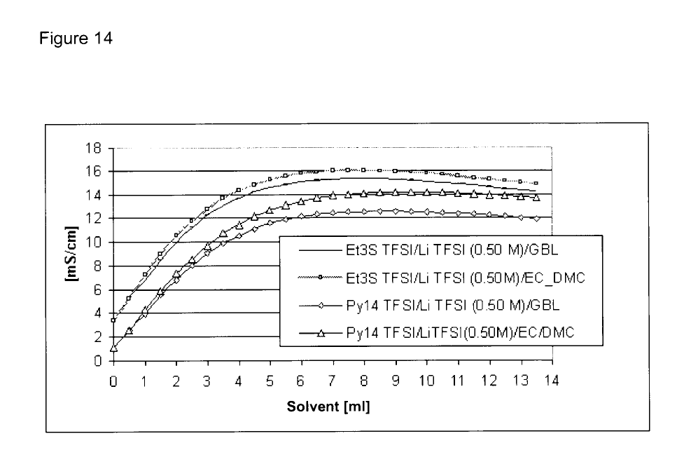

As shown in the previous chapter, [Et3S][TFSI] is one of the lowest-viscosity aprotic ILs. The starting conductivity of this compound on addition of 0.5 M LiTFSI conductive salt is 3.34 mS/cm and is three times as high as that of the [Py14][TFSI] compounds. FIG. 14 makes clear the significance of a high starting conductivity.

FIG. 14 shows the conductivities of [Et₃S][TFSI] formulations; see also “Table for FIG. 14” in the appendix.

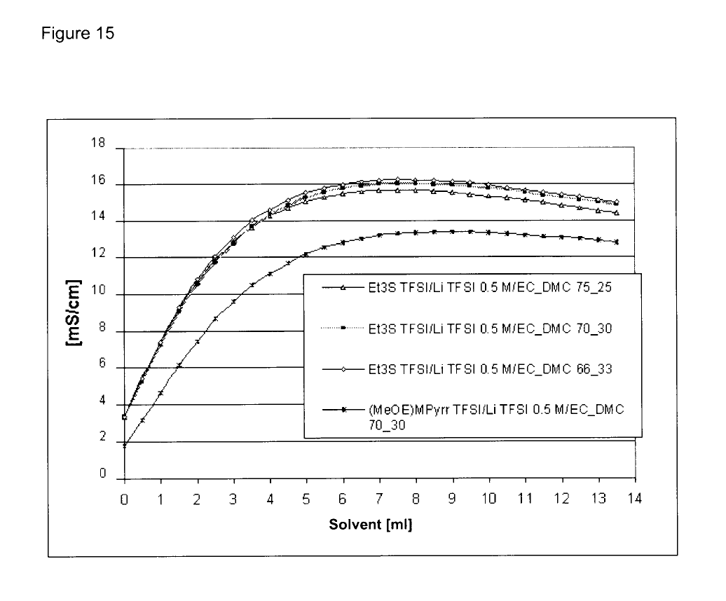

In a mixture with 0.5 M LiTFSI, on addition of 7.5 ml of EC/DMC (70:30 v/v), the highest conductivity of all electrolyte solutions studied in the course of this project of 16.04 mS/cm is achieved. Even at 30% solvent addition, which corresponds to the value of 3 ml, a conductivity of 12.77 mS/cm is obtained. This is of great significance with regard to a maximum flashpoint, which enables a low solvent content. In order to improve the high conductivity still further, the ratio of EC to DMC was optimized. For the polarity of the mixture, a maximum EC content is necessary. First, the EC content was increased to 75%, i.e. the DC content was 25%. It was found that, from a residual concentration of less than 25% DMC, the first crystal formation of the conductive salt in the electrolyte was observed, and so the concentration of EC was not increased further. It becomes clear from FIG. 15 that the increase in EC brings about a decrease in the maximum conductivity compared to the system already shown in FIG. 14. When the DMC content is increased, the maximum conductivity also increases. However, the advantage of a higher EC content is a reduced flammability, since DMC has a lower flashpoint than EC.

However, the variance of the solvent only has slight effects on the conductivity, provided that the range up to 30% solvent content in the electrolyte is employed. The difference is only 0.4 mS/cm at a maximum in the case of addition of 3 ml of solvent, and is thus negligible.

FIG. 15 shows the optimization of the [Et₃S][TFSI] electrolyte; see also “Table for FIG. 15” in the appendix.

For [Et₃S][TFSI], it can be stated in summary that, in the case of only low solvent addition of EC/DMC in a ratio of ideally, at least with regard to the conductivity, 66:33, high conductivities can be achieved rapidly even in the case of additions of only 30%. With this electrolyte, the maximum conductivities of all electrolyte formulations studied are achievable.

In a particular embodiment of the invention, the ionic liquid is therefore a sulphonium compound, preferably a trialkylsulphonium compound, more preferably [Et₃S][TFSI], [Et₃S][OTf] or [Et₃S][FSI], in which case the formulation contains DMC, DME or EC/DMC, preferably in a ratio in the range of 60-100 to 40-0, as the solvent.

In this embodiment of the invention, it is particularly preferred when the ionic liquid is [Et₃S][TFSI], and the formulation contains EC/DMC, preferably in a ratio in the range of 60-100 to 40-0, as the solvent, and LiTFSI as the conductive salt in a concentration of less than 0.75 mol/l, preferably less than 0.7 mol/I, more preferably 0.4 to 0.6 mol/l, based on the ionic liquid.

12. Flashpoints of IL-Based Formulations

In order to make statements regarding the flammability of the formulations, the flashpoint of the formulations shown in Table 5 was determined (determination to DIN ISO 2592):

TABLE 5
Flashpoints of selected electrolyte formulations.

| | Flashpoint |
|---|---|
| (MeOE)MPyr TFSI (pure IL) | 358° C. |
| (MeOE)MPyr TFSI/EC = 70:30 v/v | 174° C. |
| (MeOE)MPyr TFSI/DMC_EC = 70:30 | 62° C. |
| v/v (DMC/EC = 30:70 v/v) | |

13. Summary and Future Prospects

Proceeding from a comprehensive literature search of the primary and secondary literature, the ILs shown in Table 6 were studied as electrolytes for the lithium ion battery.

TABLE 6
ILs studied

| | | | Viscosity | Electro- | |
|---|---|---|---|---|---|
| | | | [mPa•s], | chemical | Conductivity |
| IL | Structure | Purity | 20° C. | window [V] | [mS/cm] |
| [ET3S][TFSI] | 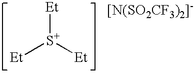 | >98% | 46.1 | 5.0 | 6.02 |
| [Py₁₄][TFSI] | 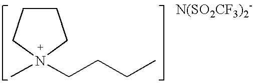 | >98% | 111.8 | 6.0 | 2.47 |
| [Py₁₄][OTf] | 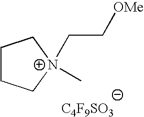 | >98% | 240.4 | 6.0 | 1.65 |
| [BMIM][OTf] | 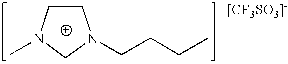 | >99% | 123.1 | 5.0 | 2.62 |
| [EdiMIM][TFSI] | 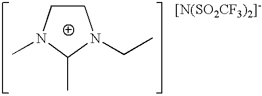 | >99% | 102.3 | 4.9 | 3.40 |
| [EMIM][TFSI] | 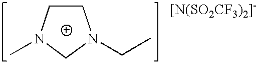 | >99% | 44.9 | 4.8 | 8.17 |
| [EMIM][BF₄] | 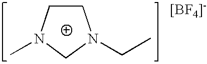 | >99% | 92.1 | 4.4 | 9.28 |

These ILs were optimized with regard to their purity, and their physicochemical characteristics were determined from the high-purity material (water content less than 20 ppm; halide content less than 50 ppm and assay greater than 99%), which are likewise reported in Table 6.

From the results and the correlation with the literature, the following sequence of the anions can be compiled with regard to the electrochemical suitability:

FSI>TFSI>C(SO₂CF₃)₃>CF₃SO₃>BF₄>CF₃COO>PF₆

For the cations, the electrochemical stability in particular is crucial in the sequence reproduced here:

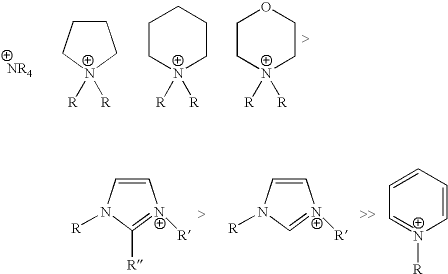

As a result of skillful design of the cation, the very stable nonaromatic ammonium compounds can also be obtained at a low viscosity, such that the electrolytes of interest can be formulated from them. This route has been taken in the synthesis of novel ionic liquids as electrolyte material. As shown below, the compound [N-methoxyethyl-N-methylpyrrolidinium][TFSI] was obtainable in good yield of 58% over two stages:

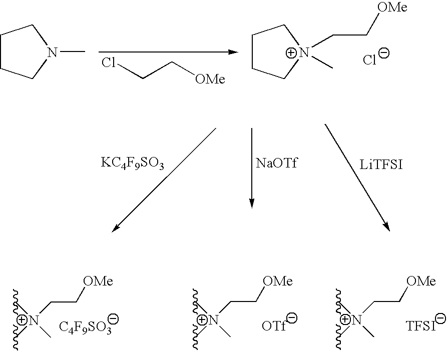

Its viscosity was halved to 58 mPa·s compared to the alkylpyrrolidinium compound, such that the range of the viscosities of the lowest-viscosity ILs was attainable. However, at the same time, the same outstanding electrochemical stabilities of the pyrrolidinium compounds with windows of 6.0 V are achieved.

In addition to the compounds described so far, [N-methoxyethyl-N-methylpyrrolidinium][TFSI] was selected for the further formulation tests. The study of the mixing behaviour of the conductive salts (LiTFSI, LiBOB, LiOTf, LiBF₄, LiPF₆ were used) showed that, in the originally planned concentration of 0.75 M, these lithium salts were usually insoluble. All tests were then carried out with 0.5 M conductive salt. Comparative conductivity measurements with the two concentrations in the [Py₁₄][TFSI]/0.5 M LiTFSI or 0.75 M LiTFSI formulation in DMSO exhibit conductivity values which are virtually comparable.

TABLE 7
Miscibility with Li conductive salts

| IL | LiTFSI | LiOTf | LiBF4 | LiPF6 | LiBOB |
|---|---|---|---|---|---|
| [ET3S][TFSI] | ++ | +/− | + | + | − |
| [Py₁₄][TFSI] | ++ | +/− | − | − | − |
| [Py₁₄][OTf] | ++ | ++ | +/− | +/− | ++ |
| [(MeOE)MPyr][TFSI] | ++ | +/− | ++ | +/− | − |
| [BMIM][OTf] | − | +/− | − | − | +/− |
| [EdiMIM][TFSI] | ++ | − | ++ | − | − |
| [EMIM][TFSI] | ++ | − | ++ | − | − |
| [EMIM][BF₄] | ++ | − | + | + | − |

In Table 7, the mixing behaviour of the electrolytes studied is reproduced. Owing to their mixing behaviour and the outstanding physicochemical characteristics, [Py₁₄][TFSI], [Et₃S][TFSI] and [(MeOE)MPyrr][TFSI] were selected as ILs. For a different reason, in spite of its very high viscosity, [Py₁₄][OTf] was likewise considered, since it is the only one of all ILs studied which exhibited a good solubility for the conductive salt LiBOB. Most conductive salts dissolve in this electrolyte, such that it would also be usable as a solubilizer. In addition, [Py₁₄][OTf] is available at significantly lower preparation costs.

In addition to dimethoxyethane, the ethylene carbonate/dimethyl carbonate mixture in a ratio of 70 to 30 has been found to be an ideal solvent for the electrolyte formulations based on ionic liquids.

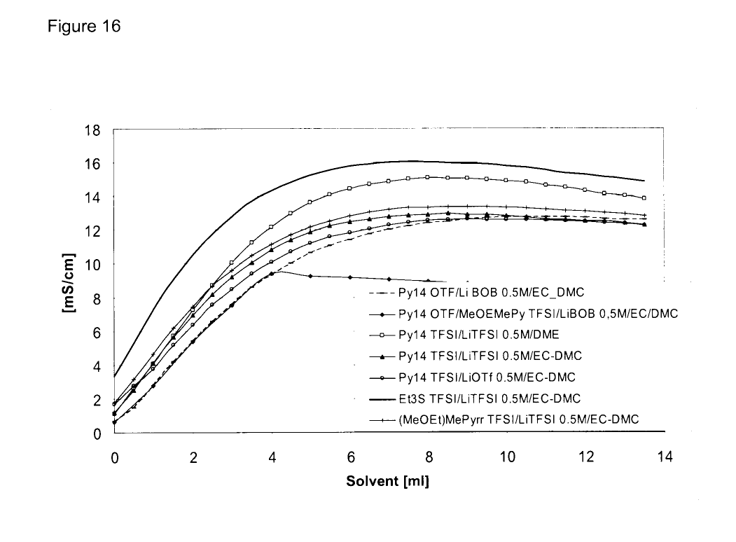

FIG. 16 shows the conductivities of the electrolye formulations; see also “Table for FIG. 16” in the appendix.

In a mixture with 0.5 M LiTFSI, the highest conductivities of all electrolyte solutions of 16.04 mS/cm are achieved with [Et₃S][TFSI] on addition of 7.5 ml of EC/DMC. Even at 30% solvent addition, which corresponds to the value of 3 ml, a conductivity of 12.77 mS/cm is obtained. This is of great significance with regard to a maximum flashpoint, which causes a low solvent content. In order to improve the high conductivity even further, the ratio of EC to DMC was optimized; the ideal ratio was found to be 66 to 33. With this electrolyte, the highest conductivities of all electrolyte formulations studied are achievable. Since an electrochemical stability of 5.0 V is sufficient, [Et₃S][TFSI] is the electrolyte material of choice.

When an even higher electrochemical stability is required, the pyrrolidinium compounds studied should be used. Especially [Py₁₄][TFSI], owing to its relatively low viscosity and the relatively high base conductivity which correlates with it, has higher conductivities than the corresponding [Py₁₄][OTf]. Attempts to reduce the viscosity with the [(MeOE)MPyr][TFSI] additive were successful, but the effect on the conductivity was only marginal. The use of [(MeOE)MPyr][TFSI] as a pure electrolyte material led to values which are increased by 0.5 mS/cm compared to [Py₁₄][TFSI].

[Py₁₄][OTf] is a very stable and inexpensive electrolyte material which, however, does not attain the conductivities of the [Et₃S][TFSI] material. In the electrolyte mixture usually used, i.e. about 30% solvent content, for example, of EC/DMC, the difference between [Py₁₄][OTf] and [Py₁₄][TFSI] is, however, not significant. Here, the use of [Py₁₄][OTf] in combination with the conductive salt LiBOB, which is significantly less expensive than LiTFSI, is advisable.

On the basis of the ionic liquids available at present and the solvents customary on the market, the electrolyte solutions found here constitute an ideal solution.

Table Appendix:

Table for FIG. 2:

| Py14TFSI | | Py14OTf | | EMIM BF4 | |
|---|---|---|---|---|---|
| U [V] | I [A] | U [V] | I [A] | U [V] | I [A] |
| 2.76 | 1.20E−04 | 2.77 | 7.32E−05 | 2.75 | 6.39E−04 |
| 2.735 | 7.20E−05 | 2.745 | 5.55E−05 | 2.726 | 5.74E−04 |
| 2.711 | 5.48E−05 | 2.721 | 4.43E−05 | 2.701 | 5.13E−04 |
| 2.686 | 4.14E−05 | 2.696 | 3.57E−05 | 2.677 | 4.57E−04 |
| 2.662 | 3.15E−05 | 2.672 | 2.90E−05 | 2.652 | 4.03E−04 |
| 2.638 | 2.43E−05 | 2.647 | 2.36E−05 | 2.628 | 3.52E−04 |
| 2.613 | 1.94E−05 | 2.623 | 1.92E−05 | 2.603 | 3.03E−04 |
| 2.564 | 1.38E−05 | 2.599 | 1.57E−05 | 2.579 | 2.57E−04 |
| 2.54 | 1.22E−05 | 2.574 | 1.28E−05 | 2.555 | 2.13E−04 |
| 2.516 | 1.10E−05 | 2.55 | 1.05E−05 | 2.53 | 1.72E−04 |
| 2.491 | 1.00E−05 | 2.525 | 8.60E−06 | 2.506 | 1.35E−04 |
| 2.467 | 9.30E−06 | 2.501 | 7.10E−06 | 2.481 | 1.03E−04 |
| 2.442 | 8.66E−06 | 2.477 | 5.94E−06 | 2.457 | 7.62E−05 |
| 2.418 | 8.12E−06 | 2.452 | 5.05E−06 | 2.433 | 5.64E−05 |
| 2.393 | 7.65E−06 | 2.428 | 4.37E−06 | 2.408 | 4.32E−05 |
| 2.369 | 7.22E−06 | 2.403 | 3.86E−06 | 2.384 | 3.54E−05 |
| 2.345 | 6.83E−06 | 2.379 | 3.46E−06 | 2.359 | 3.10E−05 |
| 2.32 | 6.47E−06 | 2.354 | 3.16E−06 | 2.335 | 2.78E−05 |
| 2.271 | 5.84E−06 | 2.33 | 2.91E−06 | 2.31 | 2.52E−05 |
| 2.247 | 5.56E−06 | 2.306 | 2.71E−06 | 2.286 | 2.31E−05 |
| 2.223 | 5.31E−06 | 2.281 | 2.54E−06 | 2.262 | 2.17E−05 |
| 2.198 | 5.07E−06 | 2.257 | 2.39E−06 | 2.237 | 2.06E−05 |
| 2.174 | 4.86E−06 | 2.232 | 2.26E−06 | 2.213 | 1.97E−05 |
| 2.149 | 4.65E−06 | 2.208 | 2.14E−06 | 2.188 | 1.91E−05 |
| 2.125 | 4.46E−06 | 2.184 | 2.03E−06 | 2.164 | 1.88E−05 |
| 2.101 | 4.28E−06 | 2.159 | 1.93E−06 | 2.14 | 1.82E−05 |
| 2.076 | 4.11E−06 | 2.135 | 1.84E−06 | 2.115 | 1.75E−05 |
| 2.052 | 3.95E−06 | 2.11 | 1.76E−06 | 2.091 | 1.67E−05 |
| 2.027 | 3.81E−06 | 2.086 | 1.68E−06 | 2.066 | 1.60E−05 |
| 2.003 | 3.67E−06 | 2.061 | 1.60E−06 | 2.042 | 1.54E−05 |
| 1.978 | 3.54E−06 | 2.037 | 1.53E−06 | 2.018 | 1.48E−05 |
| 1.954 | 3.41E−06 | 2.013 | 1.46E−06 | 1.993 | 1.43E−05 |
| 1.93 | 3.29E−06 | 1.988 | 1.40E−06 | 1.969 | 1.39E−05 |
| 1.905 | 3.17E−06 | 1.964 | 1.33E−06 | 1.944 | 1.34E−05 |
| 1.881 | 3.06E−06 | 1.939 | 1.27E−06 | 1.92 | 1.31E−05 |
| 1.856 | 2.95E−06 | 1.915 | 1.22E−06 | 1.895 | 1.27E−05 |
| 1.832 | 2.85E−06 | 1.891 | 1.16E−06 | 1.871 | 1.24E−05 |
| 1.637 | 2.14E−06 | 1.866 | 1.11E−06 | 1.847 | 1.21E−05 |
| 1.612 | 2.06E−06 | 1.842 | 1.05E−06 | 1.822 | 1.18E−05 |
| 1.568 | 1.92E−06 | 1.817 | 1.00E−06 | 1.627 | 9.60E−06 |
| 1.522 | 1.76E−06 | 1.793 | 9.55E−07 | 1.602 | 9.36E−06 |
| 1.478 | 1.61E−06 | 1.768 | 9.08E−07 | 1.559 | 8.92E−06 |
| 1.436 | 1.46E−06 | 1.744 | 8.62E−07 | 1.522 | 8.60E−06 |
| 1.395 | 1.33E−06 | 1.72 | 8.19E−07 | 1.485 | 8.12E−06 |
| 1.344 | 1.18E−06 | 1.695 | 7.76E−07 | 1.449 | 7.75E−06 |
| 1.3 | 1.07E−06 | 1.671 | 7.34E−07 | 1.412 | 7.46E−06 |
| 1.263 | 9.85E−07 | 1.646 | 6.93E−07 | 1.375 | 7.23E−06 |
| 1.219 | 8.83E−07 | 1.622 | 6.53E−07 | 1.339 | 6.81E−06 |
| 1.163 | 7.46E−07 | 1.598 | 6.14E−07 | 1.302 | 6.56E−06 |
| 1.122 | 6.37E−07 | 1.573 | 5.76E−07 | 1.266 | 6.34E−06 |
| 1.08 | 5.17E−07 | 1.549 | 5.39E−07 | 1.229 | 6.12E−06 |
| 1.039 | 3.82E−07 | 1.524 | 5.03E−07 | 1.192 | 5.97E−06 |
| 0.9921 | 2.11E−07 | 1.5 | 4.66E−07 | 1.156 | 5.70E−06 |
| 0.9116 | −1.96E−07 | 1.476 | 4.32E−07 | 1.119 | 5.52E−06 |
| 0.8603 | −5.54E−07 | 1.451 | 4.00E−07 | 1.082 | 5.36E−06 |
| 0.7993 | −9.47E−07 | 1.427 | 3.68E−07 | 1.046 | 5.14E−06 |
| 0.748 | −9.50E−07 | 1.402 | 3.38E−07 | 0.997 | 4.94E−06 |
| 0.7138 | −7.50E−07 | 1.378 | 3.08E−07 | 0.9482 | 4.59E−06 |
| 0.6772 | −4.74E−07 | 1.353 | 2.79E−07 | 0.8994 | 4.36E−06 |
| 0.6406 | −2.42E−07 | 1.329 | 2.51E−07 | 0.8505 | 4.18E−06 |
| 0.5966 | −8.38E−08 | 1.305 | 2.24E−07 | 0.8139 | 3.98E−06 |
| 0.5551 | −4.61E−08 | 1.28 | 1.97E−07 | 0.7773 | 3.82E−06 |
| 0.5185 | −8.33E−08 | 1.256 | 1.70E−07 | 0.7407 | 3.67E−06 |
| 0.4819 | −1.76E−07 | 1.231 | 1.44E−07 | 0.704 | 3.50E−06 |
| 0.4453 | −3.07E−07 | 1.207 | 1.18E−07 | 0.6674 | 3.32E−06 |
| 0.4086 | −4.54E−07 | 1.183 | 9.18E−08 | 0.6308 | 3.11E−06 |
| 0.372 | −6.17E−07 | 1.158 | 6.57E−08 | 0.5942 | 2.87E−06 |
| 0.3354 | −8.79E−07 | 1.134 | 3.91E−08 | 0.5576 | 2.58E−06 |
| 0.2988 | −1.31E−06 | 1.109 | 1.26E−08 | 0.5209 | 2.24E−06 |
| 0.2621 | −1.90E−06 | 1.085 | −1.43E−08 | 0.4843 | 1.88E−06 |
| 0.2255 | −2.58E−06 | 1.06 | −4.09E−08 | 0.4477 | 1.50E−06 |
| 0.1889 | −3.00E−06 | 1.036 | −6.73E−08 | 0.4111 | 1.14E−06 |
| 0.1523 | −2.92E−06 | 1.012 | −9.30E−08 | 0.3745 | 8.35E−07 |
| 0.1157 | −2.60E−06 | 0.9872 | −1.18E−07 | 0.3378 | 5.82E−07 |
| 7.90E−02 | −2.30E−06 | 0.9628 | −1.42E−07 | 0.3012 | 3.67E−07 |
| 4.24E−02 | −2.09E−06 | 0.9384 | −1.66E−07 | 0.2646 | 1.99E−07 |
| 5.80E−03 | −1.97E−06 | 0.914 | −1.90E−07 | 0.228 | 7.47E−08 |
| −3.08E−02 | −1.90E−06 | 0.8896 | −2.14E−07 | 0.1913 | −3.53E−08 |
| −6.74E−02 | −1.86E−06 | 0.8652 | −2.39E−07 | 0.1547 | −1.54E−07 |
| −0.1041 | −1.85E−06 | 0.8408 | −2.65E−07 | 0.1181 | −3.00E−07 |
| −0.1407 | −1.90E−06 | 0.8163 | −2.91E−07 | 8.15E−02 | −4.98E−07 |
| −0.1773 | −2.03E−06 | 0.7919 | −3.18E−07 | 4.49E−02 | −7.87E−07 |
| −0.2139 | −2.18E−06 | 0.7675 | −3.46E−07 | 8.24E−03 | −1.17E−06 |
| −0.2505 | −2.24E−06 | 0.7431 | −3.76E−07 | −2.84E−02 | −1.59E−06 |
| −0.2872 | −2.19E−06 | 0.7187 | −4.07E−07 | −6.50E−02 | −1.94E−06 |
| −0.3238 | −2.11E−06 | 0.6943 | −4.40E−07 | −0.1016 | −2.18E−06 |
| −0.3604 | −2.02E−06 | 0.6699 | −4.73E−07 | −0.1382 | −2.31E−06 |
| −0.397 | −1.95E−06 | 0.6454 | −5.07E−07 | −0.1749 | −2.37E−06 |
| −0.4337 | −1.89E−06 | 0.621 | −5.41E−07 | −0.2115 | −2.40E−06 |
| −0.4703 | −1.85E−06 | 0.5966 | −5.73E−07 | −0.2481 | −2.44E−06 |
| −0.5069 | −1.82E−06 | 0.5722 | −6.04E−07 | −0.3091 | −2.57E−06 |
| −0.5435 | −1.79E−06 | 0.5478 | −6.32E−07 | −0.3458 | −2.81E−06 |
| −0.5801 | −1.78E−06 | 0.5234 | −6.58E−07 | −0.3824 | −3.22E−06 |
| −0.6168 | −1.83E−06 | 0.499 | −6.79E−07 | −0.419 | −3.85E−06 |
| −0.6534 | −2.00E−06 | 0.4745 | −6.98E−07 | −0.4556 | −4.70E−06 |
| −0.69 | −2.15E−06 | 0.4501 | −7.16E−07 | −0.4922 | −5.71E−06 |
| −0.7266 | −2.26E−06 | 0.4257 | −7.37E−07 | −0.5289 | −6.79E−06 |
| −0.7632 | −2.35E−06 | 0.4013 | −7.61E−07 | −0.5655 | −7.82E−06 |
| −0.7999 | −2.50E−06 | 0.3769 | −7.87E−07 | −0.6021 | −8.67E−06 |
| −0.8365 | −2.71E−06 | 0.3525 | −8.15E−07 | −0.6387 | −9.31E−06 |
| −0.8731 | −3.00E−06 | 0.3281 | −8.48E−07 | −0.6754 | −9.84E−06 |
| −0.9097 | −3.35E−06 | 0.2963 | −9.05E−07 | −0.7242 | −1.06E−05 |
| −0.9464 | −3.62E−06 | 0.2597 | −1.00E−06 | −0.773 | −1.17E−05 |
| −0.983 | −3.77E−06 | 0.228 | −1.13E−06 | −0.817 | −1.26E−05 |
| −0.9952 | −3.80E−06 | 0.1987 | −1.30E−06 | −0.8585 | −1.33E−05 |
| −1.032 | −3.82E−06 | 0.162 | −1.62E−06 | −0.8951 | −1.35E−05 |
| −1.068 | −3.75E−06 | 0.1254 | −2.07E−06 | −0.9317 | −1.35E−05 |
| −1.105 | −3.68E−06 | 8.88E−02 | −2.60E−06 | −0.9683 | −1.32E−05 |
| −1.142 | −3.58E−06 | 5.22E−02 | −3.16E−06 | −1.005 | −1.29E−05 |
| −1.178 | −3.50E−06 | 1.56E−02 | −3.68E−06 | −1.042 | −1.26E−05 |
| −1.215 | −3.47E−06 | −2.11E−02 | −4.05E−06 | −1.078 | −1.23E−05 |
| −1.252 | −3.40E−06 | −5.77E−02 | −4.24E−06 | −1.115 | −1.20E−05 |
| −1.288 | −3.35E−06 | −9.43E−02 | −4.24E−06 | −1.151 | −1.18E−05 |
| −1.325 | −3.33E−06 | −0.1309 | −4.13E−06 | −1.188 | −1.16E−05 |
| −1.361 | −3.30E−06 | −0.1675 | −4.01E−06 | −1.225 | −1.14E−05 |
| −1.398 | −3.27E−06 | −0.2042 | −3.87E−06 | −1.261 | −1.12E−05 |
| −1.435 | −3.26E−06 | −0.2408 | −3.78E−06 | −1.298 | −1.11E−05 |
| −1.471 | −3.24E−06 | −0.2774 | −3.66E−06 | −1.335 | −1.09E−05 |
| −1.508 | −3.26E−06 | −0.314 | −3.55E−06 | −1.371 | −1.07E−05 |
| −1.544 | −3.25E−06 | −0.3506 | −3.42E−06 | −1.408 | −1.10E−05 |
| −1.581 | −3.29E−06 | −0.3873 | −3.30E−06 | −1.444 | −1.12E−05 |
| −1.618 | −3.33E−06 | −0.4239 | −3.20E−06 | −1.493 | −1.12E−05 |
| −1.654 | −3.39E−06 | −0.4605 | −3.15E−06 | −1.53 | −1.14E−05 |
| −1.691 | −3.48E−06 | −0.4971 | −3.10E−06 | −1.566 | −1.20E−05 |
| −1.728 | −3.61E−06 | −0.5338 | −3.04E−06 | −1.603 | −1.30E−05 |
| −1.764 | −3.75E−06 | −0.5704 | −3.26E−06 | −1.64 | −1.47E−05 |
| −1.801 | −3.90E−06 | −0.607 | −3.82E−06 | −1.676 | −1.76E−05 |
| −1.837 | −4.07E−06 | −0.6436 | −4.60E−06 | −1.713 | −2.18E−05 |
| −1.874 | −4.17E−06 | −0.6802 | −5.25E−06 | −1.75 | −2.73E−05 |
| −1.911 | −4.24E−06 | −0.7169 | −5.52E−06 | −1.786 | −3.53E−05 |
| −1.947 | −4.29E−06 | −0.7535 | −5.44E−06 | −1.823 | −4.75E−05 |
| −1.984 | −4.34E−06 | −0.7901 | −5.21E−06 | −1.859 | −6.57E−05 |
| −2.021 | −4.39E−06 | −0.8267 | −5.01E−06 | −1.896 | −9.15E−05 |
| −2.057 | −4.46E−06 | −0.8633 | −4.83E−06 | | |
| −2.094 | −4.55E−06 | −0.9 | −4.70E−06 | | |
| −2.118 | −4.63E−06 | −0.9366 | −4.60E−06 | | |
| −2.155 | −4.81E−06 | −0.9732 | −4.58E−06 | | |
| −2.191 | −5.01E−06 | −1.01 | −4.53E−06 | | |
| −2.228 | −5.35E−06 | −1.046 | −4.56E−06 | | |
| −2.265 | −5.77E−06 | −1.083 | −4.51E−06 | | |
| −2.301 | −6.43E−06 | −1.12 | −4.48E−06 | | |
| −2.338 | −7.23E−06 | −1.156 | −4.52E−06 | | |
| −2.375 | −8.05E−06 | −1.193 | −4.55E−06 | | |
| −2.411 | −8.90E−06 | −1.23 | −4.48E−06 | | |
| −2.448 | −9.54E−06 | −1.266 | −4.45E−06 | | |
| −2.484 | −9.82E−06 | −1.303 | −4.45E−06 | | |
| −2.521 | −9.96E−06 | −1.339 | −4.46E−06 | | |
| −2.558 | −9.96E−06 | −1.376 | −4.44E−06 | | |
| −2.594 | −1.01E−05 | −1.413 | −4.39E−06 | | |
| −2.631 | −1.02E−05 | −1.449 | −4.41E−06 | | |
| −2.675 | −1.03E−05 | −1.486 | −4.33E−06 | | |
| −2.716 | −1.05E−05 | −1.523 | −4.31E−06 | | |
| −2.753 | −1.06E−05 | −1.559 | −4.27E−06 | | |
| −2.79 | −1.08E−05 | −1.596 | −4.28E−06 | | |
| −2.826 | −1.11E−05 | −1.632 | −4.24E−06 | | |
| −2.863 | −1.14E−05 | −1.669 | −4.22E−06 | | |
| −2.899 | −1.20E−05 | −1.706 | −4.20E−06 | | |
| −2.936 | −1.26E−05 | −1.742 | −4.19E−06 | | |
| −2.973 | −1.37E−05 | −1.779 | −4.25E−06 | | |
| −3.009 | −1.49E−05 | −1.815 | −4.22E−06 | | |
| −3.046 | −1.70E−05 | −1.852 | −4.22E−06 | | |
| −3.083 | −2.05E−05 | −1.889 | −4.25E−06 | | |
| −3.119 | −2.68E−05 | −1.913 | −4.31E−06 | | |
| −3.156 | −3.76E−05 | −1.95 | −4.47E−06 | | |
| −3.192 | −5.42E−05 | −1.986 | −4.56E−06 | | |
| −3.229 | −7.61E−05 | −2.023 | −4.54E−06 | | |
| −3.241 | −8.46E−05 | −2.06 | −4.56E−06 | | |
| −3.278 | −1.13E−04 | −2.096 | −4.65E−06 | | |
| −3.29 | −1.23E−04 | −2.133 | −4.80E−06 | | |
| | | −2.157 | −4.94E−06 | | |
| | | −2.194 | −5.16E−06 | | |
| | | −2.231 | −5.43E−06 | | |
| | | −2.267 | −5.72E−06 | | |
| | | −2.304 | −6.12E−06 | | |
| | | −2.34 | −6.70E−06 | | |
| | | −2.377 | −7.46E−06 | | |
| | | −2.414 | −8.25E−06 | | |
| | | −2.45 | −8.84E−06 | | |
| | | −2.487 | −9.16E−06 | | |
| | | −2.523 | −9.44E−06 | | |
| | | −2.56 | −9.70E−06 | | |
| | | −2.597 | −1.00E−05 | | |
| | | −2.633 | −1.03E−05 | | |
| | | −2.67 | −1.05E−05 | | |
| | | −2.707 | −1.06E−05 | | |
| | | −2.743 | −1.07E−05 | | |
| | | −2.78 | −1.08E−05 | | |
| | | −2.816 | −1.11E−05 | | |
| | | −2.853 | −1.13E−05 | | |
| | | −2.89 | −1.15E−05 | | |
| | | −2.926 | −1.18E−05 | | |
| | | −2.963 | −1.22E−05 | | |
| | | −3 | −1.30E−05 | | |
| | | −3.036 | −1.47E−05 | | |
| | | −3.073 | −1.92E−05 | | |
| | | −3.109 | −2.81E−05 | | |
| | | −3.146 | −4.12E−05 | | |
| | | −3.183 | −5.72E−05 | | |
| | | −3.219 | −7.53E−05 | | |
| | | −3.256 | −9.47E−05 | | |
| | | −3.293 | −1.15E−04 | | |
| | | −3.275 | −1.16E−04 | | |
| | | −3.239 | −9.56E−05 | | |

Table for FIG. 3:

| EMIM TFSI | | Et3STFSI | | EDiMIM TFSI | |
|---|---|---|---|---|---|
| U [V] | I [A] | U [V] | I [A] | U [V] | I [A] |
| 2.898 | 8.72E−04 | −2.75 | −7.87E−04 | 2.6 | 3.21E−04 |
| 2.874 | 7.78E−04 | −2.706 | −6.64E−04 | 2.576 | 3.59E−04 |
| 2.849 | 6.94E−04 | −2.657 | −5.35E−04 | 2.551 | 3.23E−04 |
| 2.825 | 6.18E−04 | −2.608 | −4.16E−04 | 2.527 | 2.90E−04 |
| 2.8 | 5.48E−04 | −2.572 | −3.34E−04 | 2.502 | 2.59E−04 |
| 2.776 | 4.83E−04 | −2.535 | −2.60E−04 | 2.478 | 2.29E−04 |
| 2.751 | 4.21E−04 | −2.498 | −1.96E−04 | 2.453 | 2.00E−04 |
| 2.727 | 3.64E−04 | −2.462 | −1.42E−04 | 2.429 | 1.73E−04 |
| 2.703 | 3.11E−04 | −2.425 | −9.88E−05 | 2.405 | 1.48E−04 |
| 2.678 | 2.61E−04 | −2.389 | −6.67E−05 | 2.38 | 1.24E−04 |
| 2.654 | 2.16E−04 | −2.352 | −4.46E−05 | 2.356 | 1.02E−04 |
| 2.622 | 1.63E−04 | −2.315 | −3.06E−05 | 2.324 | 7.65E−05 |
| 2.581 | 1.05E−04 | −2.279 | −2.14E−05 | 2.283 | 5.00E−05 |
| 2.551 | 7.36E−05 | −2.242 | −1.56E−05 | 2.253 | 3.65E−05 |
| 2.52 | 4.77E−05 | −2.206 | −1.18E−05 | 2.222 | 2.68E−05 |
| 2.493 | 3.22E−05 | −2.169 | −9.09E−06 | 2.195 | 2.16E−05 |
| 2.458 | 1.94E−05 | −2.132 | −7.34E−06 | 2.16 | 1.78E−05 |
| 2.434 | 1.38E−05 | −2.096 | −5.95E−06 | 2.136 | 1.61E−05 |
| 2.41 | 1.02E−05 | −2.059 | −5.09E−06 | 2.112 | 1.49E−05 |
| 2.385 | 7.93E−06 | −2.022 | −4.32E−06 | 2.087 | 1.39E−05 |
| 2.361 | 6.49E−06 | −1.986 | −3.73E−06 | 2.063 | 1.31E−05 |
| 2.336 | 5.58E−06 | −1.949 | −3.28E−06 | 2.038 | 1.24E−05 |
| 2.312 | 4.96E−06 | −1.913 | −2.94E−06 | 2.014 | 1.17E−05 |
| 2.288 | 4.53E−06 | −1.876 | −2.65E−06 | 1.99 | 1.11E−05 |
| 2.263 | 4.19E−06 | −1.839 | −2.41E−06 | 1.965 | 1.06E−05 |
| 2.239 | 3.92E−06 | −1.803 | −2.30E−06 | 1.941 | 1.02E−05 |
| 2.214 | 3.67E−06 | −1.766 | −2.10E−06 | 1.916 | 9.71E−06 |
| 2.19 | 3.45E−06 | −1.729 | −1.92E−06 | 1.892 | 9.31E−06 |
| 2.166 | 3.24E−06 | −1.693 | −1.77E−06 | 1.868 | 8.93E−06 |
| 2.141 | 3.03E−06 | −1.656 | −1.62E−06 | 1.843 | 8.58E−06 |
| 2.117 | 2.83E−06 | −1.62 | −1.51E−06 | 1.819 | 8.25E−06 |
| 2.092 | 2.63E−06 | −1.583 | −1.38E−06 | 1.794 | 7.94E−06 |
| 2.068 | 2.44E−06 | −1.546 | −1.27E−06 | 1.77 | 7.66E−06 |
| 2.043 | 2.25E−06 | −1.51 | −1.15E−06 | 1.745 | 7.39E−06 |
| 2.019 | 2.07E−06 | −1.473 | −1.09E−06 | 1.721 | 7.15E−06 |
| 1.995 | 1.91E−06 | −1.436 | −9.72E−07 | 1.697 | 6.92E−06 |
| 1.97 | 1.76E−06 | −1.4 | −8.65E−07 | 1.672 | 6.71E−06 |
| 1.946 | 1.63E−06 | −1.363 | −7.66E−07 | 1.648 | 6.51E−06 |
| 1.921 | 1.51E−06 | −1.327 | −6.73E−07 | 1.623 | 6.32E−06 |
| 1.897 | 1.40E−06 | −1.29 | −5.84E−07 | 1.599 | 6.14E−06 |
| 1.873 | 1.29E−06 | −1.253 | −5.00E−07 | 1.575 | 5.98E−06 |
| 1.848 | 1.20E−06 | −1.217 | −4.17E−07 | 1.55 | 5.82E−06 |
| 1.824 | 1.10E−06 | −1.18 | −3.35E−07 | 1.526 | 5.68E−06 |
| 1.799 | 1.02E−06 | −1.143 | −2.52E−07 | 1.501 | 5.55E−06 |
| 1.775 | 9.31E−07 | −1.107 | −1.68E−07 | 1.477 | 5.42E−06 |
| 1.75 | 8.51E−07 | −1.07 | −7.87E−08 | 1.452 | 5.30E−06 |
| 1.726 | 7.80E−07 | −1.034 | 1.35E−08 | 1.428 | 5.18E−06 |
| 1.702 | 7.15E−07 | −0.997 | 1.10E−07 | 1.404 | 5.07E−06 |
| 1.677 | 6.57E−07 | −0.9604 | 2.01E−07 | 1.379 | 4.96E−06 |
| 1.653 | 6.04E−07 | −0.9238 | 2.84E−07 | 1.355 | 4.85E−06 |
| 1.628 | 5.55E−07 | −0.8871 | 3.60E−07 | 1.33 | 4.74E−06 |
| 1.604 | 5.09E−07 | −0.8505 | 4.32E−07 | 1.306 | 4.63E−06 |
| 1.58 | 4.65E−07 | −0.8139 | 5.00E−07 | 1.282 | 4.52E−06 |
| 1.555 | 4.25E−07 | −0.7773 | 5.64E−07 | 1.257 | 4.41E−06 |
| 1.531 | 3.86E−07 | −0.7407 | 6.21E−07 | 1.233 | 4.30E−06 |
| 1.506 | 3.51E−07 | −0.704 | 6.76E−07 | 1.208 | 4.18E−06 |
| 1.482 | 3.16E−07 | −0.6552 | 7.44E−07 | 1.184 | 4.07E−06 |
| 1.458 | 2.83E−07 | −0.6064 | 8.08E−07 | 1.16 | 3.95E−06 |
| 1.433 | 2.51E−07 | −0.5576 | 8.61E−07 | 1.135 | 3.83E−06 |
| 1.409 | 2.20E−07 | −0.5209 | 8.91E−07 | 1.111 | 3.71E−06 |
| 1.377 | 1.81E−07 | −0.4843 | 9.20E−07 | 1.079 | 3.56E−06 |
| 1.345 | 1.43E−07 | −0.4477 | 9.49E−07 | 1.047 | 3.43E−06 |
| 1.316 | 1.08E−07 | −0.4111 | 9.74E−07 | 1.018 | 3.32E−06 |
| 1.284 | 6.94E−08 | −0.3745 | 9.96E−07 | 0.9862 | 3.23E−06 |
| 1.25 | 2.74E−08 | −0.3378 | 1.01E−06 | 0.952 | 3.15E−06 |
| 1.216 | −1.48E−08 | −0.3012 | 1.03E−06 | 0.9178 | 3.08E−06 |
| 1.167 | −7.63E−08 | −0.2646 | 1.05E−06 | 0.869 | 2.98E−06 |
| 1.135 | −1.16E−07 | −0.228 | 1.07E−06 | 0.8372 | 2.91E−06 |
| 1.099 | −1.61E−07 | −0.1913 | 1.10E−06 | 0.8006 | 2.81E−06 |
| 1.052 | −2.16E−07 | −0.1547 | 1.13E−06 | 0.7542 | 2.66E−06 |
| 1.021 | −2.51E−07 | −0.1181 | 1.16E−06 | 0.7225 | 2.53E−06 |
| 0.9888 | −2.83E−07 | −8.15E−02 | 1.19E−06 | 0.6908 | 2.39E−06 |
| 0.9619 | −3.09E−07 | −4.49E−02 | 1.22E−06 | 0.6639 | 2.25E−06 |
| 0.9448 | −3.24E−07 | −8.24E−03 | 1.25E−06 | 0.6468 | 2.16E−06 |
| 0.9058 | −3.58E−07 | 2.84E−02 | 1.29E−06 | 0.6078 | 1.93E−06 |
| 0.8716 | −3.86E−07 | 6.50E−02 | 1.33E−06 | 0.5736 | 1.73E−06 |
| 0.8423 | −4.09E−07 | 0.1016 | 1.38E−06 | 0.5443 | 1.56E−06 |
| 0.8105 | −4.33E−07 | 0.1382 | 1.44E−06 | 0.5125 | 1.37E−06 |
| 0.7739 | −4.62E−07 | 0.1749 | 1.51E−06 | 0.4759 | 1.06E−06 |
| 0.7397 | −4.89E−07 | 0.2115 | 1.56E−06 | 0.4417 | 6.03E−07 |
| 0.7056 | −5.15E−07 | 0.2481 | 1.61E−06 | 0.4076 | −5.64E−08 |
| 0.6763 | −5.38E−07 | 0.2847 | 1.67E−06 | 0.3783 | −6.65E−07 |
| 0.6421 | −5.65E−07 | 0.3214 | 1.75E−06 | 0.3441 | −1.34E−06 |
| 0.6104 | −5.91E−07 | 0.358 | 1.82E−06 | 0.3123 | −2.06E−06 |
| 0.5811 | −6.15E−07 | 0.3946 | 1.88E−06 | 0.2831 | −2.96E−06 |
| 0.5518 | −6.41E−07 | 0.4312 | 1.95E−06 | 0.2538 | −4.24E−06 |
| 0.52 | −6.71E−07 | 0.4678 | 2.01E−06 | 0.222 | −6.16E−06 |
| 0.4883 | −7.04E−07 | 0.5045 | 2.07E−06 | 0.1903 | −8.56E−06 |
| 0.4565 | −7.44E−07 | 0.5411 | 2.13E−06 | 0.1585 | −1.12E−05 |
| 0.4248 | −7.93E−07 | 0.5777 | 2.19E−06 | 0.1268 | −1.39E−05 |
| 0.3931 | −8.58E−07 | 0.6143 | 2.25E−06 | 9.51E−02 | −1.59E−05 |
| 0.3638 | −9.38E−07 | 0.6509 | 2.32E−06 | 6.58E−02 | −1.65E−05 |
| 0.3345 | −1.05E−06 | 0.6876 | 2.39E−06 | 3.65E−02 | −1.60E−05 |
| 0.3076 | −1.21E−06 | 0.7242 | 2.45E−06 | 9.61E−03 | −1.47E−05 |
| 0.2783 | −1.47E−06 | 0.7608 | 2.51E−06 | −1.97E−02 | −1.33E−05 |
| 0.249 | −1.91E−06 | 0.7974 | 2.56E−06 | −4.90E−02 | −1.19E−05 |
| 0.2173 | −2.84E−06 | 0.834 | 2.62E−06 | −8.07E−02 | −1.08E−05 |
| 0.188 | −4.60E−06 | 0.8707 | 2.70E−06 | −0.11 | −1.01E−05 |
| 0.1563 | −8.26E−06 | 0.9073 | 2.78E−06 | −0.1418 | −9.57E−06 |
| 0.127 | −1.37E−05 | 0.9439 | 2.90E−06 | −0.1711 | −9.45E−06 |
| 9.52E−02 | −2.09E−05 | 0.9805 | 3.07E−06 | −0.2028 | −9.62E−06 |
| 6.35E−02 | −2.71E−05 | 1.017 | 3.33E−06 | −0.2345 | −9.89E−06 |
| 3.42E−02 | −2.99E−05 | 1.054 | 3.71E−06 | −0.2638 | −1.01E−05 |
| 4.88E−03 | −2.90E−05 | 1.09 | 4.32E−06 | −0.2931 | −1.02E−05 |
| −2.69E−02 | −2.56E−05 | 1.127 | 5.53E−06 | −0.3249 | −1.03E−05 |
| −5.86E−02 | −2.19E−05 | 1.164 | 8.16E−06 | −0.3566 | −1.02E−05 |
| −9.03E−02 | −1.93E−05 | 1.2 | 1.39E−05 | −0.3883 | −1.01E−05 |
| −0.117 | −1.83E−05 | 1.237 | 2.45E−05 | −0.4152 | −9.96E−06 |
| −0.148 | −1.87E−05 | 1.273 | 3.90E−05 | −0.4469 | −9.73E−06 |
| −0.178 | −1.99E−05 | 1.31 | 5.22E−05 | −0.4762 | −9.48E−06 |
| −0.21 | −2.20E−05 | 1.347 | 5.82E−05 | −0.508 | −9.18E−06 |
| −0.246 | −2.67E−05 | 1.383 | 5.53E−05 | −0.5446 | −8.85E−06 |
| −0.268 | −2.98E−05 | 1.42 | 4.89E−05 | −0.5666 | −8.68E−06 |
| −0.288 | −3.13E−05 | 1.457 | 4.34E−05 | −0.5861 | −8.56E−06 |
| −0.312 | −3.13E−05 | 1.493 | 3.95E−05 | −0.6105 | −8.47E−06 |
| −0.341 | −2.94E−05 | 1.53 | 3.67E−05 | −0.6398 | −8.47E−06 |
| −0.368 | −2.69E−05 | 1.566 | 3.47E−05 | −0.6667 | −8.59E−06 |
| −0.402 | −2.37E−05 | 1.603 | 3.34E−05 | −0.7008 | −8.99E−06 |
| −0.434 | −2.10E−05 | 1.64 | 3.28E−05 | −0.7326 | −9.62E−06 |
| −0.468 | −1.87E−05 | 1.676 | 3.28E−05 | −0.7668 | −1.07E−05 |
| −0.502 | −1.68E−05 | 1.713 | 3.32E−05 | −0.8009 | −1.24E−05 |
| −0.537 | −1.54E−05 | 1.75 | 3.30E−05 | −0.8351 | −1.45E−05 |
| −0.566 | −1.44E−05 | 1.786 | 3.22E−05 | −0.8644 | −1.64E−05 |
| −0.593 | −1.37E−05 | 1.823 | 3.15E−05 | −0.8913 | −1.82E−05 |
| −0.622 | −1.32E−05 | 1.859 | 3.10E−05 | −0.9206 | −2.02E−05 |
| −0.649 | −1.30E−05 | 1.896 | 3.03E−05 | −0.9474 | −2.20E−05 |
| −0.673 | −1.31E−05 | 1.933 | 2.97E−05 | −0.9718 | −2.35E−05 |
| −0.698 | −1.36E−05 | 1.969 | 2.95E−05 | −0.9962 | −2.49E−05 |
| −0.722 | −1.46E−05 | 2.006 | 2.99E−05 | −1.021 | −2.60E−05 |
| −0.747 | −1.66E−05 | 2.043 | 3.09E−05 | −1.045 | −2.67E−05 |
| −0.771 | −1.95E−05 | 2.079 | 3.28E−05 | −1.069 | −2.71E−05 |
| −0.795 | −2.33E−05 | 2.128 | 3.60E−05 | −1.094 | −2.72E−05 |
| −0.820 | −2.71E−05 | 2.165 | 3.75E−05 | −1.118 | −2.72E−05 |
| −0.844 | −2.84E−05 | 2.201 | 3.75E−05 | −1.143 | −2.70E−05 |
| −0.869 | −2.74E−05 | 2.238 | 3.70E−05 | −1.167 | −2.68E−05 |
| −0.893 | −2.60E−05 | 2.274 | 3.70E−05 | −1.192 | −2.67E−05 |
| −0.918 | −2.47E−05 | 2.311 | 3.79E−05 | −1.216 | −2.66E−05 |
| −0.942 | −2.33E−05 | 2.348 | 3.97E−05 | −1.24 | −2.65E−05 |
| −0.966 | −2.20E−05 | 2.384 | 4.19E−05 | −1.265 | −2.65E−05 |
| −1.003 | −2.02E−05 | 2.433 | 4.53E−05 | −1.301 | −2.66E−05 |
| −1.04 | −1.86E−05 | 2.47 | 4.84E−05 | −1.338 | −2.67E−05 |
| −1.077 | −1.73E−05 | 2.509 | 5.38E−05 | −1.375 | −2.67E−05 |
| −1.113 | −1.62E−05 | 2.558 | 6.77E−05 | −1.411 | −2.66E−05 |
| −1.15 | −1.53E−05 | 2.597 | 8.77E−05 | −1.448 | −2.62E−05 |
| −1.187 | −1.46E−05 | 2.628 | 1.11E−04 | −1.485 | −2.56E−05 |
| −1.223 | −1.39E−05 | 2.67 | 1.51E−04 | −1.521 | −2.47E−05 |
| −1.26 | −1.33E−05 | 2.714 | 2.08E−04 | −1.558 | −2.36E−05 |
| −1.296 | −1.28E−05 | 2.746 | 2.58E−04 | −1.594 | −2.25E−05 |
| −1.333 | −1.23E−05 | 2.726 | 2.18E−04 | −1.631 | −2.16E−05 |
| −1.37 | −1.19E−05 | 2.692 | 1.62E−04 | −1.668 | −2.09E−05 |
| −1.406 | −1.16E−05 | | | −1.704 | −2.02E−05 |
| −1.443 | −1.13E−05 | | | −1.741 | −1.97E−05 |
| −1.479 | −1.11E−05 | | | −1.777 | −1.93E−05 |
| −1.516 | −1.09E−05 | | | −1.814 | −1.90E−05 |
| −1.553 | −1.08E−05 | | | −1.851 | −1.87E−05 |
| −1.589 | −1.08E−05 | | | −1.887 | −1.85E−05 |
| −1.626 | −1.09E−05 | | | −1.924 | −1.84E−05 |
| −1.663 | −1.11E−05 | | | −1.961 | −1.84E−05 |
| −1.699 | −1.11E−05 | | | −1.997 | −1.84E−05 |
| −1.736 | −1.12E−05 | | | −2.034 | −1.86E−05 |
| −1.772 | −1.14E−05 | | | −2.07 | −1.89E−05 |
| −1.809 | −1.18E−05 | | | −2.107 | −1.97E−05 |
| −1.846 | −1.25E−05 | | | −2.144 | −2.10E−05 |
| −1.882 | −1.39E−05 | | | −2.18 | −2.27E−05 |
| −1.919 | −1.69E−05 | | | −2.217 | −2.50E−05 |
| −1.956 | −2.35E−05 | | | −2.254 | −2.77E−05 |
| −1.992 | −2.69E−05 | | | −2.29 | −3.12E−05 |
| −2.029 | −3.14E−05 | | | −2.327 | −3.57E−05 |
| −2.065 | −3.91E−05 | | | −2.363 | −4.14E−05 |
| −2.102 | −5.08E−05 | | | −2.4 | −4.94E−05 |
| −2.139 | −6.67E−05 | | | −2.437 | −6.17E−05 |
| −2.175 | −8.69E−05 | | | −2.473 | −8.12E−05 |
| −2.212 | −1.12E−04 | | | −2.51 | −1.08E−04 |
| −2.249 | −1.42E−04 | | | −2.547 | −1.40E−04 |
| −2.285 | −1.80E−04 | | | −2.583 | −1.77E−04 |
| −2.322 | −2.27E−04 | | | −2.62 | −2.18E−04 |
| −2.358 | −2.88E−04 | | | −2.656 | −2.62E−04 |
| −2.395 | −3.62E−04 | | | −2.693 | −3.07E−04 |
| −2.432 | −4.48E−04 | | | −2.73 | −3.53E−04 |
| −2.468 | −5.42E−04 | | | −2.737 | −3.62E−04 |
| −2.495 | −6.15E−04 | | | | |
| −2.458 | −5.13E−04 | | | | |
| −2.422 | −4.17E−04 | | | | |
| −2.385 | −3.30E−04 | | | | |

Table for FIG. 4: Mean viscosities at temperatures of −10° C. to 80° C.

| | η(BMIM OTf) | η(EdiMIM TFSI) | η(EMIM TFSI) |
|---|---|---|---|
| Temp. [° C.] | [mPas] | [mPas] | [mPas] |
| −10 | 792.05 | 604.24 | 190.63 |
| 0 | 390.45 | 300.25 | 107.81 |
| 10 | 212.78 | 167.41 | 67.00 |
| 20 | 123.16 | 102.33 | 44.89 |
| 30 | 76.98 | 66.53 | 31.64 |
| 40 | 49.01 | 43.71 | 22.36 |
| 50 | 35.65 | 32.38 | 17.59 |
| 60 | 25.89 | 24.21 | 13.74 |
| 70 | 19.54 | 18.45 | 11.01 |
| 80 | 15.25 | 14.58 | 9.00 |

Table for FIG. 5: Mean viscosities at temperatures of −10° C. to 80° C.

| | η(Py14 OTf) | η(Py14 TFSI) | η(Et3S TFSI) |
|---|---|---|---|
| Temp. [° C.] | [mPas] | [mPas] | [mPas] |
| −10 | 1932.07 | 716.93 | 205.44 |
| 0 | 861.45 | 343.15 | 114.16 |
| 10 | 434.65 | 185.70 | 69.74 |
| 20 | 240.44 | 111.76 | 46.11 |
| 30 | 141.85 | 71.33 | 31.71 |
| 40 | 85.89 | 46.14 | 22.01 |
| 50 | 60.26 | 33.87 | 17.14 |
| 60 | 42.53 | 24.86 | 13.22 |
| 70 | 31.27 | 18.88 | 10.59 |
| 80 | 23.74 | 14.82 | 8.56 |

Table for FIG. 6: Mean viscosities at temperatures of −10° C. to 80° C.

| | η((MeOE)DiMIM | η((MeOE)Pyrr | η((MeOE)MIM | η((MeOE)Pyrr | η(Py14 |
|---|---|---|---|---|---|
| | TFSI) | TFSI) | TFSI) | nonaflate) | TFSI) |
| Temp. [° C.] | [mPas] | [mPas] | [mPas] | [mPas] | [mPas] |
| −10 | 634.8 | 310.6 | 296.2 | 3926.7 | 716.93 |
| 0 | 276.7 | 158.6 | 142.9 | 1572.4 | 343.15 |
| 10 | 141.5 | 90.7 | 78.8 | 707.1 | 185.70 |
| 20 | 83.0 | 58.3 | 48.2 | 378.1 | 111.76 |
| 30 | 50.7 | 38.4 | 31.9 | 203.0 | 71.33 |
| 40 | 33.3 | 26.7 | 22.0 | 117.9 | 46.14 |
| 50 | 23.2 | 19.4 | 16.0 | 73.0 | 33.87 |
| 60 | 16.9 | 14.6 | 12.1 | 48.2 | 24.86 |
| 70 | 12.8 | 11.4 | 9.4 | 33.4 | 18.88 |
| 80 | 9.9 | 9.2 | 7.6 | 23.9 | 14.82 |

Table for FIG. 7:

| MeOEMPyrr TFSI | | MeOEMIM TFSI | | MeOEDiMIM TFSI | | MeOEMPyrr nonaflate | |
|---|---|---|---|---|---|---|---|
| U [V] | I [A] | U [V] | I [A] | U [V] | I [A] | U [V] | I [A] |
| 3 | 3.34E−04 | 2.743 | 2.79E−04 | −2.843 | −5.11E−04 | 2.993 | 1.13E−04 |
| 2.976 | 3.78E−04 | 2.706 | 2.23E−04 | −2.806 | −4.60E−04 | 2.956 | 9.71E−05 |
| 2.951 | 3.44E−04 | 2.669 | 1.74E−04 | −2.769 | −4.11E−04 | 2.919 | 8.44E−05 |
| 2.927 | 3.11E−04 | 2.633 | 1.32E−04 | −2.733 | −3.65E−04 | 2.883 | 7.33E−05 |
| 2.902 | 2.79E−04 | 2.596 | 9.75E−05 | −2.696 | −3.22E−04 | 2.846 | 6.35E−05 |
| 2.878 | 2.48E−04 | 2.56 | 7.01E−05 | −2.66 | −2.80E−04 | 2.81 | 5.45E−05 |
| 2.854 | 2.18E−04 | 2.523 | 5.01E−05 | −2.623 | −2.42E−04 | 2.773 | 4.63E−05 |
| 2.829 | 1.90E−04 | 2.486 | 3.67E−05 | −2.586 | −2.06E−04 | 2.736 | 3.91E−05 |
| 2.805 | 1.64E−04 | 2.45 | 2.83E−05 | −2.55 | −1.75E−04 | 2.7 | 3.28E−05 |
| 2.78 | 1.38E−04 | 2.413 | 2.31E−05 | −2.513 | −1.47E−04 | 2.663 | 2.75E−05 |
| 2.756 | 1.15E−04 | 2.376 | 1.96E−05 | −2.477 | −1.24E−04 | 2.626 | 2.36E−05 |
| 2.724 | 8.74E−05 | 2.34 | 1.72E−05 | −2.44 | −1.04E−04 | 2.59 | 2.10E−05 |
| 2.683 | 5.78E−05 | 2.303 | 1.56E−05 | −2.403 | −8.67E−05 | 2.553 | 1.94E−05 |
| 2.653 | 4.17E−05 | 2.267 | 1.44E−05 | −2.367 | −7.20E−05 | 2.517 | 1.84E−05 |
| 2.622 | 2.89E−05 | 2.23 | 1.36E−05 | −2.33 | −5.91E−05 | 2.48 | 1.79E−05 |
| 2.595 | 2.16E−05 | 2.193 | 1.29E−05 | −2.293 | −4.83E−05 | 2.443 | 1.75E−05 |
| 2.561 | 1.59E−05 | 2.157 | 1.23E−05 | −2.257 | −3.90E−05 | 2.407 | 1.71E−05 |
| 2.536 | 1.34E−05 | 2.12 | 1.15E−05 | −2.22 | −3.12E−05 | 2.37 | 1.67E−05 |
| 2.512 | 1.18E−05 | 2.083 | 1.05E−05 | −2.184 | −2.48E−05 | 2.334 | 1.64E−05 |
| 2.487 | 1.06E−05 | 2.022 | 8.12E−06 | −2.122 | −1.66E−05 | 2.272 | 1.58E−05 |
| 2.463 | 9.82E−06 | 1.986 | 7.18E−06 | −2.086 | −1.29E−05 | 2.236 | 1.54E−05 |
| 2.439 | 9.19E−06 | 1.949 | 6.60E−06 | −2.049 | −1.00E−05 | 2.199 | 1.51E−05 |
| 2.414 | 8.66E−06 | 1.913 | 6.30E−06 | −2.013 | −7.77E−06 | 2.163 | 1.47E−05 |
| 2.39 | 8.20E−06 | 1.876 | 6.17E−06 | −1.976 | −6.02E−06 | 2.126 | 1.44E−05 |
| 2.365 | 7.80E−06 | 1.839 | 6.12E−06 | −1.939 | −4.70E−06 | 2.089 | 1.40E−05 |
| 2.341 | 7.44E−06 | 1.803 | 6.12E−06 | −1.903 | −3.69E−06 | 2.053 | 1.37E−05 |
| 2.316 | 7.10E−06 | 1.766 | 6.18E−06 | −1.866 | −2.93E−06 | 2.016 | 1.34E−05 |
| 2.292 | 6.80E−06 | 1.729 | 6.26E−06 | −1.83 | −2.37E−06 | 1.98 | 1.31E−05 |
| 2.268 | 6.52E−06 | 1.693 | 6.26E−06 | −1.793 | −1.95E−06 | 1.943 | 1.28E−05 |
| 2.243 | 6.27E−06 | 1.656 | 6.10E−06 | −1.756 | −1.64E−06 | 1.906 | 1.25E−05 |
| 2.219 | 6.04E−06 | 1.62 | 5.76E−06 | −1.72 | −1.39E−06 | 1.87 | 1.22E−05 |
| 2.194 | 5.84E−06 | 1.583 | 5.39E−06 | −1.683 | −1.19E−06 | 1.833 | 1.19E−05 |
| 2.17 | 5.66E−06 | 1.546 | 5.20E−06 | −1.646 | −9.81E−07 | 1.796 | 1.17E−05 |
| 2.146 | 5.51E−06 | 1.51 | 5.11E−06 | −1.61 | −7.52E−07 | 1.76 | 1.14E−05 |
| 2.121 | 5.37E−06 | 1.473 | 4.98E−06 | −1.573 | −4.62E−07 | 1.723 | 1.11E−05 |
| 2.097 | 5.24E−06 | 1.436 | 4.84E−06 | −1.537 | −7.88E−08 | 1.687 | 1.09E−05 |
| 2.072 | 5.12E−06 | 1.4 | 4.66E−06 | −1.5 | 4.41E−07 | 1.65 | 1.06E−05 |
| 2.048 | 5.00E−06 | 1.363 | 4.42E−06 | −1.463 | 1.15E−06 | 1.613 | 1.04E−05 |
| 2.023 | 4.88E−06 | 1.327 | 4.10E−06 | −1.427 | 2.09E−06 | 1.577 | 1.02E−05 |
| 1.999 | 4.77E−06 | 1.29 | 3.71E−06 | −1.39 | 3.33E−06 | 1.54 | 9.93E−06 |
| 1.975 | 4.67E−06 | 1.253 | 3.28E−06 | −1.353 | 4.92E−06 | 1.503 | 9.71E−06 |
| 1.95 | 4.57E−06 | 1.217 | 2.84E−06 | −1.317 | 6.91E−06 | 1.467 | 9.49E−06 |
| 1.926 | 4.47E−06 | 1.18 | 2.45E−06 | −1.28 | 9.27E−06 | 1.43 | 9.26E−06 |
| 1.901 | 4.37E−06 | 1.143 | 2.12E−06 | −1.244 | 1.19E−05 | 1.394 | 9.04E−06 |
| 1.877 | 4.28E−06 | 1.107 | 1.84E−06 | −1.207 | 1.47E−05 | 1.357 | 8.83E−06 |
| 1.853 | 4.18E−06 | 1.07 | 1.62E−06 | −1.17 | 1.74E−05 | 1.32 | 8.61E−06 |
| 1.828 | 4.09E−06 | 1.034 | 1.43E−06 | −1.134 | 1.96E−05 | 1.284 | 8.39E−06 |
| 1.804 | 4.00E−06 | 0.997 | 1.27E−06 | −1.097 | 2.10E−05 | 1.247 | 8.17E−06 |
| 1.779 | 3.91E−06 | 0.9604 | 1.13E−06 | −1.06 | 2.15E−05 | 1.21 | 7.95E−06 |
| 1.755 | 3.82E−06 | 0.9238 | 1.02E−06 | −1.024 | 2.10E−05 | 1.174 | 7.73E−06 |
| 1.73 | 3.73E−06 | 0.8871 | 9.11E−07 | −0.9872 | 2.00E−05 | 1.137 | 7.51E−06 |
| 1.706 | 3.64E−06 | 0.8505 | 8.01E−07 | −0.9506 | 1.88E−05 | 1.101 | 7.29E−06 |
| 1.682 | 3.55E−06 | 0.8139 | 6.78E−07 | −0.914 | 1.80E−05 | 1.064 | 7.07E−06 |
| 1.657 | 3.46E−06 | 0.7773 | 5.48E−07 | −0.8774 | 1.81E−05 | 1.027 | 6.85E−06 |
| 1.633 | 3.37E−06 | 0.7382 | 4.04E−07 | −0.8383 | 1.87E−05 | 0.9883 | 6.60E−06 |
| 1.608 | 3.29E−06 | 0.704 | 2.97E−07 | −0.8041 | 1.87E−05 | 0.9541 | 6.38E−06 |
| 1.584 | 3.21E−06 | 0.6674 | 2.11E−07 | −0.7675 | 1.78E−05 | 0.9175 | 6.14E−06 |
| 1.56 | 3.13E−06 | 0.643 | 1.62E−07 | −0.7431 | 1.69E−05 | 0.8931 | 5.97E−06 |
| 1.535 | 3.05E−06 | 0.6186 | 1.19E−07 | −0.7187 | 1.60E−05 | 0.8687 | 5.80E−06 |
| 1.511 | 2.97E−06 | 0.6064 | 9.88E−08 | −0.7065 | 1.56E−05 | 0.8565 | 5.71E−06 |
| 1.479 | 2.88E−06 | 0.5869 | 6.78E−08 | −0.687 | 1.50E−05 | 0.8369 | 5.56E−06 |
| 1.447 | 2.78E−06 | 0.5453 | 3.95E−09 | −0.6454 | 1.43E−05 | 0.7954 | 5.23E−06 |
| 1.418 | 2.70E−06 | 0.5087 | −5.11E−08 | −0.6088 | 1.45E−05 | 0.7588 | 4.93E−06 |
| 1.386 | 2.61E−06 | 0.4721 | −1.06E−07 | −0.5722 | 1.64E−05 | 0.7222 | 4.62E−06 |
| 1.352 | 2.52E−06 | 0.4355 | −1.61E−07 | −0.5356 | 2.12E−05 | 0.6856 | 4.32E−06 |
| 1.318 | 2.44E−06 | 0.3989 | −2.15E−07 | −0.499 | 2.96E−05 | 0.649 | 4.04E−06 |
| 1.269 | 2.32E−06 | 0.3622 | −2.70E−07 | −0.4623 | 4.09E−05 | 0.6123 | 3.77E−06 |
| 1.237 | 2.25E−06 | 0.3256 | −3.35E−07 | −0.4257 | 5.28E−05 | 0.5757 | 3.51E−06 |
| 1.201 | 2.17E−06 | 0.289 | −4.21E−07 | −0.3891 | 6.22E−05 | 0.5391 | 3.25E−06 |
| 1.154 | 2.07E−06 | 0.2524 | −5.30E−07 | −0.3525 | 6.50E−05 | 0.5025 | 3.00E−06 |
| 1.123 | 2.00E−06 | 0.2158 | −6.53E−07 | −0.3159 | 5.86E−05 | 0.4659 | 2.75E−06 |
| 1.091 | 1.93E−06 | 0.1791 | −7.82E−07 | −0.2792 | 4.91E−05 | 0.4292 | 2.51E−06 |
| 1.064 | 1.87E−06 | 0.1425 | −9.17E−07 | −0.2426 | 4.21E−05 | 0.3926 | 2.27E−06 |
| 1.047 | 1.83E−06 | 0.1059 | −1.06E−06 | −0.206 | 3.70E−05 | 0.356 | 2.03E−06 |
| 1.008 | 1.75E−06 | 6.93E−02 | −1.16E−06 | −0.1694 | 3.33E−05 | 0.3194 | 1.79E−06 |
| 0.9737 | 1.68E−06 | 3.27E−02 | −1.24E−06 | −0.1328 | 3.05E−05 | 0.2827 | 1.56E−06 |
| 0.9444 | 1.62E−06 | −3.97E−03 | −1.30E−06 | −9.61E−02 | 2.82E−05 | 0.2461 | 1.36E−06 |
| 0.9126 | 1.55E−06 | −4.06E−02 | −1.39E−06 | −5.95E−02 | 2.63E−05 | 0.2095 | 1.17E−06 |
| 0.876 | 1.48E−06 | −7.72E−02 | −1.53E−06 | −2.29E−02 | 2.48E−05 | 0.1729 | 1.01E−06 |
| 0.8418 | 1.41E−06 | −0.1138 | −1.76E−06 | 1.37E−02 | 2.34E−05 | 0.1363 | 8.54E−07 |
| 0.8076 | 1.34E−06 | −0.1505 | −2.09E−06 | 5.04E−02 | 2.23E−05 | 9.96E−02 | 7.09E−07 |
| 0.7784 | 1.27E−06 | −0.1871 | −2.42E−06 | 8.70E−02 | 2.13E−05 | 6.30E−02 | 5.66E−07 |
| 0.7442 | 1.20E−06 | −0.2237 | −2.63E−06 | 0.1236 | 2.04E−05 | 2.64E−02 | 4.23E−07 |
| 0.7124 | 1.13E−06 | −0.2603 | −2.70E−06 | 0.1602 | 1.96E−05 | −1.02E−02 | 2.84E−07 |
| 0.6831 | 1.06E−06 | −0.2969 | −2.75E−06 | 0.1968 | 1.89E−05 | −4.68E−02 | 1.52E−07 |
| 0.6538 | 9.83E−07 | −0.3336 | −2.82E−06 | 0.2335 | 1.82E−05 | −8.35E−02 | 3.85E−08 |
| 0.6221 | 8.91E−07 | −0.3702 | −2.92E−06 | 0.2701 | 1.77E−05 | −0.1201 | −5.16E−08 |
| 0.5904 | 7.83E−07 | −0.4068 | −3.04E−06 | 0.3067 | 1.72E−05 | −0.1567 | −1.20E−07 |
| 0.5586 | 6.52E−07 | −0.4434 | −3.21E−06 | 0.3433 | 1.68E−05 | −0.1933 | −1.73E−07 |
| 0.5269 | 4.94E−07 | −0.48 | −3.48E−06 | 0.3799 | 1.66E−05 | −0.23 | −2.14E−07 |
| 0.4951 | 3.08E−07 | −0.5167 | −3.94E−06 | 0.4166 | 1.63E−05 | −0.2666 | −2.49E−07 |
| 0.4659 | 1.12E−07 | −0.5533 | −4.72E−06 | 0.4532 | 1.62E−05 | −0.3032 | −2.79E−07 |
| 0.4366 | −1.15E−07 | −0.5899 | −6.01E−06 | 0.4898 | 1.62E−05 | −0.3398 | −3.05E−07 |
| 0.4097 | −3.53E−07 | −0.6265 | −7.80E−06 | 0.5264 | 1.61E−05 | −0.3764 | −3.30E−07 |
| 0.3804 | −6.53E−07 | −0.6631 | −9.82E−06 | 0.563 | 1.59E−05 | −0.4131 | −3.54E−07 |
| 0.3511 | −1.04E−06 | −0.6998 | −1.27E−05 | 0.5997 | 1.56E−05 | −0.4497 | −3.80E−07 |
| 0.3194 | −1.68E−06 | −0.7364 | −1.70E−05 | 0.6363 | 1.53E−05 | −0.4863 | −4.08E−07 |
| 0.2901 | −2.59E−06 | −0.773 | −2.18E−05 | 0.6729 | 1.51E−05 | −0.5229 | −4.43E−07 |
| 0.2583 | −3.95E−06 | −0.8096 | −2.58E−05 | 0.7095 | 1.49E−05 | −0.5595 | −4.84E−07 |
| 0.229 | −5.42E−06 | −0.8463 | −2.78E−05 | 0.7462 | 1.47E−05 | −0.5962 | −5.37E−07 |
| 0.1973 | −7.14E−06 | −0.8829 | −2.77E−05 | 0.7828 | 1.45E−05 | −0.6328 | −6.02E−07 |
| 0.1656 | −9.12E−06 | −0.9195 | −2.62E−05 | 0.8194 | 1.44E−05 | −0.6694 | −6.86E−07 |
| 0.1363 | −1.13E−05 | −0.9561 | −2.43E−05 | 0.856 | 1.44E−05 | −0.706 | −7.95E−07 |
| 0.107 | −1.38E−05 | −0.9927 | −2.24E−05 | 0.8926 | 1.44E−05 | −0.7426 | −9.36E−07 |
| 7.52E−02 | −1.66E−05 | −1.005 | −2.19E−05 | 0.9048 | 1.44E−05 | −0.7549 | −9.91E−07 |
| 4.35E−02 | −1.90E−05 | −1.042 | −2.04E−05 | 0.9415 | 1.45E−05 | −0.7915 | −1.19E−06 |
| 1.18E−02 | −2.07E−05 | −1.078 | −1.90E−05 | 0.9781 | 1.47E−05 | −0.8281 | −1.45E−06 |
| −1.51E−02 | −2.14E−05 | −1.115 | −1.79E−05 | 1.015 | 1.48E−05 | −0.8647 | −1.79E−06 |
| −4.68E−02 | −2.15E−05 | −1.151 | −1.68E−05 | 1.051 | 1.50E−05 | −0.9013 | −2.23E−06 |
| −7.61E−02 | −2.11E−05 | −1.188 | −1.59E−05 | 1.088 | 1.52E−05 | −0.938 | −2.80E−06 |
| −0.1079 | −2.03E−05 | −1.225 | −1.52E−05 | 1.125 | 1.54E−05 | −0.9746 | −3.48E−06 |
| −0.1445 | −1.92E−05 | −1.261 | −1.44E−05 | 1.161 | 1.57E−05 | −1.011 | −4.30E−06 |
| −0.1665 | −1.85E−05 | −1.298 | −1.37E−05 | 1.198 | 1.59E−05 | −1.048 | −5.23E−06 |
| −0.186 | −1.80E−05 | −1.335 | −1.31E−05 | 1.234 | 1.62E−05 | −1.084 | −6.29E−06 |
| −0.2104 | −1.74E−05 | −1.371 | −1.27E−05 | 1.271 | 1.64E−05 | −1.121 | −7.45E−06 |
| −0.2397 | −1.66E−05 | −1.408 | −1.23E−05 | 1.308 | 1.65E−05 | −1.158 | −8.59E−06 |
| −0.2666 | −1.60E−05 | −1.444 | −1.19E−05 | 1.344 | 1.65E−05 | −1.194 | −9.65E−06 |
| −0.3008 | −1.53E−05 | −1.481 | −1.17E−05 | 1.381 | 1.64E−05 | −1.231 | −1.07E−05 |
| −0.3325 | −1.47E−05 | −1.518 | −1.14E−05 | 1.418 | 1.62E−05 | −1.268 | −1.16E−05 |
| −0.3667 | −1.42E−05 | −1.554 | −1.13E−05 | 1.454 | 1.60E−05 | −1.304 | −1.23E−05 |
| −0.4008 | −1.37E−05 | −1.591 | −1.12E−05 | 1.491 | 1.58E−05 | −1.341 | −1.30E−05 |
| −0.435 | −1.32E−05 | −1.628 | −1.12E−05 | 1.527 | 1.56E−05 | −1.377 | −1.37E−05 |
| −0.4643 | −1.29E−05 | −1.664 | −1.13E−05 | 1.564 | 1.54E−05 | −1.414 | −1.44E−05 |
| −0.4912 | −1.26E−05 | −1.701 | −1.13E−05 | 1.601 | 1.52E−05 | −1.451 | −1.56E−05 |
| −0.5205 | −1.23E−05 | −1.737 | −1.15E−05 | 1.637 | 1.50E−05 | −1.487 | −1.85E−05 |
| −0.5473 | −1.21E−05 | −1.774 | −1.17E−05 | 1.674 | 1.48E−05 | −1.524 | −2.44E−05 |
| −0.5717 | −1.19E−05 | −1.811 | −1.21E−05 | 1.711 | 1.46E−05 | −1.561 | −3.23E−05 |
| −0.5962 | −1.17E−05 | −1.847 | −1.27E−05 | 1.747 | 1.44E−05 | −1.597 | −4.09E−05 |
| −0.6206 | −1.16E−05 | −1.884 | −1.35E−05 | 1.784 | 1.43E−05 | −1.634 | −4.99E−05 |
| −0.645 | −1.14E−05 | −1.92 | −1.47E−05 | 1.82 | 1.41E−05 | −1.67 | −5.88E−05 |
| −0.6694 | −1.13E−05 | −1.957 | −1.64E−05 | 1.857 | 1.40E−05 | −1.707 | −6.77E−05 |
| −0.6938 | −1.11E−05 | −1.994 | −1.85E−05 | 1.894 | 1.40E−05 | −1.744 | −7.63E−05 |
| −0.7182 | −1.09E−05 | −2.03 | −2.12E−05 | 1.93 | 1.40E−05 | −1.78 | −8.44E−05 |
| −0.7426 | −1.08E−05 | −2.067 | −2.42E−05 | 1.967 | 1.41E−05 | −1.817 | −9.15E−05 |
| −0.7671 | −1.06E−05 | −2.104 | −2.75E−05 | 2.003 | 1.42E−05 | −1.853 | −9.69E−05 |
| −0.7915 | −1.05E−05 | −2.128 | −3.13E−05 | 2.028 | 1.43E−05 | −1.878 | −9.90E−05 |
| −0.8159 | −1.03E−05 | −2.165 | −4.10E−05 | 2.065 | 1.46E−05 | −1.915 | −9.74E−05 |
| −0.8403 | −1.02E−05 | −2.201 | −5.80E−05 | 2.101 | 1.51E−05 | −1.951 | −8.67E−05 |
| −0.8647 | −1.01E−05 | −2.238 | −8.44E−05 | 2.138 | 1.59E−05 | −1.988 | −5.03E−05 |
| −0.9013 | −9.99E−06 | −2.274 | −1.21E−04 | 2.174 | 1.74E−05 | −2.024 | −2.15E−05 |
| −0.938 | −9.83E−06 | −2.311 | −1.65E−04 | 2.211 | 2.10E−05 | −2.061 | −1.55E−05 |
| −0.9746 | −9.72E−06 | −2.348 | −2.16E−04 | 2.248 | 2.86E−05 | −2.098 | −1.23E−05 |
| −1.011 | −9.62E−06 | −2.384 | −2.70E−04 | 2.284 | 4.25E−05 | −2.134 | −1.03E−05 |
| −1.048 | −9.48E−06 | −2.421 | −3.28E−04 | 2.321 | 6.35E−05 | −2.171 | −8.84E−06 |
| −1.084 | −9.40E−06 | −2.458 | −3.88E−04 | 2.357 | 9.02E−05 | −2.207 | −7.79E−06 |
| −1.121 | −9.34E−06 | −2.494 | −4.50E−04 | 2.394 | 1.21E−04 | −2.244 | −7.09E−06 |
| −1.158 | −9.34E−06 | −2.531 | −5.12E−04 | 2.431 | 1.56E−04 | −2.281 | −6.51E−06 |
| −1.194 | −9.35E−06 | −2.567 | −5.77E−04 | 2.467 | 1.92E−04 | −2.317 | −6.14E−06 |
| −1.231 | −9.37E−06 | −2.604 | −6.42E−04 | 2.504 | 2.30E−04 | −2.354 | −5.92E−06 |
| −1.268 | −9.49E−06 | −2.641 | −7.07E−04 | | | −2.391 | −5.85E−06 |
| −1.304 | −9.63E−06 | −2.685 | −7.86E−04 | | | −2.435 | −5.99E−06 |
| −1.341 | −9.64E−06 | | | | | −2.476 | −6.33E−06 |
| −1.377 | −9.64E−06 | | | | | −2.513 | −6.67E−06 |
| −1.414 | −9.71E−06 | | | | | −2.549 | −7.20E−06 |
| −1.451 | −9.80E−06 | | | | | −2.586 | −7.64E−06 |
| −1.487 | −9.96E−06 | | | | | −2.623 | −8.17E−06 |
| −1.524 | −1.01E−05 | | | | | −2.659 | −8.81E−06 |
| −1.561 | −1.02E−05 | | | | | −2.696 | −9.35E−06 |
| −1.597 | −1.05E−05 | | | | | −2.732 | −9.96E−06 |
| −1.634 | −1.06E−05 | | | | | −2.769 | −1.06E−05 |
| −1.67 | −1.08E−05 | | | | | −2.806 | −1.13E−05 |
| −1.707 | −1.09E−05 | | | | | −2.842 | −1.20E−05 |
| −1.744 | −1.10E−05 | | | | | −2.879 | −1.28E−05 |
| −1.78 | −1.11E−05 | | | | | −2.915 | −1.35E−05 |
| −1.817 | −1.11E−05 | | | | | −2.952 | −1.41E−05 |
| −1.853 | −1.12E−05 | | | | | −2.989 | −1.46E−05 |
| −1.89 | −1.12E−05 | | | | | −3.001 | −1.47E−05 |
| −1.927 | −1.12E−05 | | | | | −3.038 | −1.50E−05 |
| −1.963 | −1.12E−05 | | | | | −3.074 | −1.54E−05 |
| −2 | −1.13E−05 | | | | | | |
| −2.037 | −1.17E−05 | | | | | | |
| −2.073 | −1.20E−05 | | | | | | |
| −2.11 | −1.22E−05 | | | | | | |
| −2.146 | −1.21E−05 | | | | | | |
| −2.183 | −1.21E−05 | | | | | | |
| −2.22 | −1.22E−05 | | | | | | |
| −2.256 | −1.24E−05 | | | | | | |
| −2.293 | −1.26E−05 | | | | | | |
| −2.33 | −1.30E−05 | | | | | | |
| −2.366 | −1.32E−05 | | | | | | |
| −2.403 | −1.36E−05 | | | | | | |
| −2.439 | −1.40E−05 | | | | | | |
| −2.476 | −1.46E−05 | | | | | | |
| −2.513 | −1.52E−05 | | | | | | |
| −2.549 | −1.59E−05 | | | | | | |
| −2.586 | −1.69E−05 | | | | | | |
| −2.623 | −1.87E−05 | | | | | | |
| −2.659 | −2.18E−05 | | | | | | |
| −2.696 | −2.71E−05 | | | | | | |
| −2.732 | −3.49E−05 | | | | | | |
| −2.769 | −4.48E−05 | | | | | | |
| −2.806 | −5.40E−05 | | | | | | |
| −2.842 | −5.83E−05 | | | | | | |
| −2.879 | −5.99E−05 | | | | | | |
| −2.915 | −6.31E−05 | | | | | | |
| −2.952 | −6.82E−05 | | | | | | |
| −2.989 | −7.39E−05 | | | | | | |
| −3.016 | −7.89E−05 | | | | | | |
| −3.05 | −8.71E−05 | | | | | | |
| −3.082 | −9.78E−05 | | | | | | |
| −3.116 | −1.15E−04 | | | | | | |
| −3.184 | −1.69E−04 | | | | | | |
| −3.221 | −2.07E−04 | | | | | | |
| −3.243 | −2.30E−04 | | | | | | |
| −3.218 | −1.99E−04 | | | | | | |
| −3.199 | −1.76E−04 | | | | | | |

Table for FIG. 8: Conductivities of different IL-containing
compositions on addition of the amount specified in each
case of the solvent specified to 5 ml of the starting sample
(IL plus conductive salt as specified).

| | σ(Py14TFSI/ | σ(Py14TFSI/ | σ(Py14TFSI/ | σ(Py14TFSI/ |
|---|---|---|---|---|
| | LiTFSI | LiTFSI | LiTFSI | LiTFSI |
| | 0.75 M/ | 0.50 M/ | 0.75 M/ | 0.50 M/ |
| Solvent | GBL) | GBL) | DMSO | DMSO) |
| added [ml] | [mS/cm] | [mS/cm] | [mS/cm] | [mS/cm] |
| 0.0 | 0.70 | 1.12 | 0.71 | 1.13 |
| 0.5 | 1.97 | 2.59 | 2.20 | 2.66 |
| 1.0 | 3.28 | 3.93 | 3.07 | 3.91 |
| 1.5 | 4.69 | 5.54 | 4.34 | 5.31 |
| 2.0 | 5.95 | 6.79 | 5.72 | 6.60 |
| 2.5 | 7.11 | 8.06 | 6.92 | 7.88 |
| 3.0 | 8.17 | 9.08 | 7.97 | 8.82 |
| 3.5 | 9.06 | 9.91 | 8.95 | 9.56 |
| 4.0 | 9.82 | 10.52 | 9.61 | 10.26 |
| 4.5 | 10.43 | 11.11 | 10.23 | 10.75 |
| 5.0 | 10.90 | 11.60 | 10.72 | 11.17 |
| 5.5 | 11.28 | 11.90 | 11.04 | 11.51 |
| 6.0 | 11.55 | 12.16 | 11.32 | 11.68 |
| 6.5 | 11.79 | 12.35 | 11.51 | 11.84 |
| 7.0 | 11.97 | 12.45 | 11.69 | 11.98 |
| 7.5 | 12.09 | 12.54 | 11.79 | 12.07 |
| 8.0 | 12.18 | 12.54 | 11.85 | 12.16 |
| 8.5 | 12.20 | 12.57 | 11.91 | 12.16 |
| 9.0 | 12.24 | 12.57 | 11.91 | 12.16 |
| 9.5 | 12.24 | 12.54 | 11.83 | 12.13 |
| 10.0 | 12.24 | 12.52 | 11.75 | 12.07 |
| 10.5 | 12.18 | 12.46 | 11.69 | 12.01 |
| 11.0 | 12.13 | 12.40 | 11.63 | 11.97 |
| 11.5 | 12.09 | 12.35 | 11.58 | 11.78 |
| 12.0 | 12.01 | 12.28 | 11.51 | 11.75 |
| 12.5 | 11.91 | 12.16 | 11.40 | 11.65 |
| 13.0 | 11.82 | 12.04 | 11.32 | 11.51 |
| 13.5 | | 11.96 | 11.23 | 11.42 |

Table for FIG. 9: Conductivities of different IL-containing compositions on addition of
the amount specified in each case of the solvent specified to 5 ml of the starting sample
(IL plus conductive salt as specified).

| Solvent | σ(Py14TFSI/ | σ(Py14TFSI/ | σ(Py14TFSI/ | σ(Py14TFSI/ | σ(Py14TFSI/ | σ(Py14TFSI/ |
|---|---|---|---|---|---|---|
| added | GBL) | DMSO) | EC&DMC) | DMC) | E(EG)2E) | DME) |
| [ml] | [mS/cm] | [mS/cm] | [mS/cm] | [mS/cm] | [mS/cm] | [mS/cm] |
| 0.0 | 1.00 | 2.38 | 2.39 | 2.38 | 2.38 | 2.42 |
| 0.5 | 0.93 | 4.32 | 4.68 | 4.82 | 3.15 | 4.50 |
| 1.0 | 0.86 | 6.02 | 6.52 | 6.73 | 3.78 | 6.45 |
| 1.5 | 0.81 | 7.51 | 8.39 | 8.83 | 4.25 | 8.50 |
| 2.0 | 0.76 | 8.88 | 9.74 | 10.34 | 4.55 | 10.07 |
| 2.5 | 0.71 | 9.86 | 10.93 | 11.62 | 4.84 | 11.51 |
| 3.0 | 0.67 | 10.68 | 11.76 | 12.42 | 5.00 | 12.54 |
| 3.5 | 0.64 | 11.31 | 12.51 | 13.07 | 5.14 | 13.61 |
| 4.0 | 0.61 | 11.78 | 12.97 | 13.42 | 5.18 | 14.21 |
| 4.5 | 0.58 | 12.21 | 13.42 | 13.56 | 5.21 | 14.78 |
| 5.0 | 0.55 | 12.40 | 13.64 | 13.55 | 5.17 | 15.12 |
| 5.5 | 0.53 | 12.54 | 13.86 | 13.42 | 5.14 | 15.45 |
| 6.0 | 0.51 | 12.66 | 13.97 | 13.20 | 5.09 | 15.51 |
| 6.5 | 0.49 | 12.74 | 14.00 | 12.89 | 5.00 | 15.62 |
| 7.0 | 0.47 | 12.77 | 13.97 | 12.58 | 4.90 | 15.66 |
| 7.5 | 0.45 | 12.75 | 13.93 | 12.21 | 4.79 | 15.62 |
| 8.0 | 0.44 | 12.69 | 13.87 | 11.88 | 4.69 | 15.54 |
| 8.5 | 0.42 | 12.54 | 13.83 | 11.45 | 4.56 | 15.41 |
| 9.0 | 0.41 | 12.52 | 13.75 | 11.09 | 4.48 | 15.26 |
| 9.5 | 0.39 | 12.40 | 13.64 | 10.72 | 4.35 | 15.12 |
| 10.0 | 0.38 | 12.32 | 13.53 | 10.37 | 4.25 | 14.89 |
| 10.5 | 0.37 | 12.21 | 13.42 | 9.95 | 4.15 | 14.65 |
| 11.0 | 0.36 | 12.11 | 13.29 | 9.64 | 4.04 | 14.53 |
| 11.5 | 0.35 | 11.98 | 13.16 | 9.29 | 3.95 | 14.29 |
| 12.0 | 0.34 | 11.87 | 13.02 | 8.93 | 3.83 | 14.06 |
| 12.5 | | | | | 3.73 | 13.86 |
| 13.0 | | | | | 3.63 | 13.61 |
| 13.5 | | | | | 3.53 | 13.40 |

Table for FIG. 10: Conductivities of different IL-containing
compositions on addition of the amount specified in each
case of the solvent specified to 5 ml of the starting sample
(IL plus conductive salt as specified).

| | σ(Py14TFSI/ | σ(Py14TFSI/ | σ(Py14TFSI/ | σ(Py14TFSI/ |
|---|---|---|---|---|
| | LiTFSI (0.50 | LiTFSI (0.50 | LiTFSI (0.50 | LiTFSI (0.50 |
| Solvent | M)/GBL) | M)/DMSO) | M)/DME) | M)/EC/DMC) |
| added [ml] | [mS/cm] | [mS/cm] | [mS/cm] | [mS/cm] |
| 0.0 | 1.12 | 1.13 | 1.12 | 1.12 |
| 0.5 | 2.59 | 2.66 | 2.63 | 2.54 |
| 1.0 | 3.93 | 3.91 | 4.05 | 4.29 |
| 1.5 | 5.54 | 5.31 | 5.71 | 5.83 |
| 2.0 | 6.79 | 6.60 | 7.24 | 7.33 |
| 2.5 | 8.06 | 7.88 | 8.72 | 8.58 |
| 3.0 | 9.08 | 8.82 | 10.05 | 9.73 |
| 3.5 | 9.91 | 9.56 | 11.23 | 10.74 |
| 4.0 | 10.52 | 10.26 | 12.18 | 11.45 |
| 4.5 | 11.11 | 10.75 | 12.97 | 12.18 |
| 5.0 | 11.60 | 11.17 | 13.61 | 12.69 |
| 5.5 | 11.90 | 11.51 | 14.08 | 13.11 |
| 6.0 | 12.16 | 11.68 | 14.42 | 13.42 |
| 6.5 | 12.35 | 11.84 | 14.69 | 13.69 |
| 7.0 | 12.45 | 11.98 | 14.86 | 13.92 |
| 7.5 | 12.54 | 12.07 | 14.99 | 13.97 |
| 8.0 | 12.54 | 12.16 | 15.09 | 14.10 |
| 8.5 | 12.57 | 12.16 | 15.06 | 14.18 |
| 9.0 | 12.57 | 12.16 | 15.03 | 14.17 |
| 9.5 | 12.54 | 12.13 | 14.98 | 14.17 |
| 10.0 | 12.52 | 12.07 | 14.89 | 14.14 |
| 10.5 | 12.46 | 12.01 | 14.80 | 14.14 |
| 11.0 | 12.40 | 11.97 | 14.63 | 14.08 |
| 11.5 | 12.35 | 11.78 | 14.50 | 14.03 |
| 12.0 | 12.28 | 11.75 | 14.30 | 13.96 |
| 12.5 | 12.16 | 11.65 | 14.14 | 13.85 |
| 13.0 | 12.04 | 11.51 | 14.00 | 13.76 |
| 13.5 | 11.96 | 11.42 | 13.80 | 13.68 |

Table for FIG. 11: Conductivities of different IL-containing
compositions on addition of the amount specified in each
case of the solvent specified to 5 ml of the starting sample
(IL plus conductive salt as specified).

| | σ(Py14TFSI/ | | |
|---|---|---|---|
| | LiOTf 0.50 | σ(Py14TFSI/LiOTf | σ(Py14TFSI/LiOTf |
| Solvent added | M/GBL) | 0.50 M/DME) | 0.50 M/EC/DMC) |
| [ml] | [mS/cm] | [mS/cm] | [mS/cm] |
| 0.0 | 1.63 | 1.62 | 1.68 |
| 0.5 | 2.32 | 2.53 | 2.76 |
| 1.0 | 3.60 | 4.04 | 3.78 |
| 1.5 | 4.96 | 5.52 | 5.20 |
| 2.0 | 6.23 | 7.10 | 6.39 |
| 2.5 | 7.39 | 8.65 | 7.56 |
| 3.0 | 8.39 | 9.88 | 8.49 |
| 3.5 | 9.16 | 10.86 | 9.39 |
| 4.0 | 9.84 | 11.73 | 10.10 |
| 4.5 | 10.34 | 12.39 | 10.72 |
| 5.0 | 10.83 | 12.98 | 11.20 |
| 5.5 | 11.18 | 13.39 | 11.60 |
| 6.0 | 11.45 | 13.77 | 11.84 |
| 6.5 | 11.68 | 13.98 | 12.07 |
| 7.0 | 11.84 | 14.10 | 12.28 |
| 7.5 | 11.96 | 14.19 | 12.43 |
| 8.0 | 12.07 | 14.25 | 12.54 |
| 8.5 | 12.07 | 14.25 | 12.57 |
| 9.0 | 12.07 | 14.25 | 12.62 |
| 9.5 | 12.06 | 14.19 | 12.60 |
| 10.0 | 12.06 | 14.09 | 12.60 |
| 10.5 | 11.98 | 13.97 | 12.57 |
| 11.0 | 11.95 | 13.83 | 12.54 |
| 11.5 | 11.91 | 13.72 | 12.52 |
| 12.0 | 11.84 | 13.58 | 12.46 |
| 12.5 | 11.72 | 13.36 | 12.40 |
| 13.0 | 11.62 | 13.21 | 12.35 |
| 13.5 | 11.51 | 13.02 | 12.24 |

Table for FIG. 12: Conductivities of different IL-containing
compositions on addition of the amount specified in each
case of the solvent specified to 5 ml of the starting sample
(IL plus conductive salt as specified).

| | σ(Py14OTf/ | σ(Py14OTf/ | | |
|---|---|---|---|---|
| | LiBOB | LiTFSI | | |
| Solvent | 0.5 M/ | 0.5 M/ | σ(Py14OTf/—/ | σ(Py14TFSI/—/ |
| added | EC_DMC) | EC-DMC) | EC_DMC) | EC_DMC) |
| [ml] | [mS/cm] | [mS/cm] | [mS/cm] | [mS/cm] |
| 0.0 | 1.63 | 1.62 | 1.68 | 1.68 |
| 0.5 | 2.32 | 2.53 | 2.76 | 2.76 |
| 1.0 | 3.60 | 4.04 | 3.78 | 3.78 |
| 1.5 | 4.96 | 5.52 | 5.20 | 5.20 |
| 2.0 | 6.23 | 7.10 | 6.39 | 6.39 |
| 2.5 | 7.39 | 8.65 | 7.56 | 7.56 |
| 3.0 | 8.39 | 9.88 | 8.49 | 8.49 |
| 3.5 | 9.16 | 10.86 | 9.39 | 9.39 |
| 4.0 | 9.84 | 11.73 | 10.10 | 10.10 |
| 4.5 | 10.34 | 12.39 | 10.72 | 10.72 |
| 5.0 | 10.83 | 12.98 | 11.20 | 11.20 |
| 5.5 | 11.18 | 13.39 | 11.60 | 11.60 |
| 6.0 | 11.45 | 13.77 | 11.84 | 11.84 |
| 6.5 | 11.68 | 13.98 | 12.07 | 12.07 |
| 7.0 | 11.84 | 14.10 | 12.28 | 12.28 |
| 7.5 | 11.96 | 14.19 | 12.43 | 12.43 |
| 8.0 | 12.07 | 14.25 | 12.54 | 12.54 |
| 8.5 | 12.07 | 14.25 | 12.57 | 12.57 |
| 9.0 | 12.07 | 14.25 | 12.62 | 12.62 |
| 9.5 | 12.06 | 14.19 | 12.60 | 12.60 |
| 10.0 | 12.06 | 14.09 | 12.60 | 12.60 |
| 10.5 | 11.98 | 13.97 | 12.57 | 12.57 |
| 11.0 | 11.95 | 13.83 | 12.54 | 12.54 |
| 11.5 | 11.91 | 13.72 | 12.52 | 12.52 |
| 12.0 | 11.84 | 13.58 | 12.46 | 12.46 |
| 12.5 | 11.72 | 13.36 | 12.40 | 12.40 |
| 13.0 | 11.62 | 13.21 | 12.35 | 12.35 |
| 13.5 | 11.51 | 13.02 | 12.24 | 12.24 |

Table for FIG. 13: Conductivities of different IL-containing
compositions on addition of the amount specified in each
case of the solvent specified to 5 ml of the starting sample
(IL plus conductive salt as specified).

| | σ((MeOE)MPyrr | σ((MeOE)MPyrr | | |
|---|---|---|---|---|
| | TFSI/—/ | TFSI/LiTFSI 0.5 | σ(Py14 | |
| | EC_DMC | M/EC_DMC | TFSI/LiTFSI 0.5 | σ(Py14TFSI/—/ |
| Solvent added | 70_30 | 70_30) | M/EC_DMC) | EC_DMC) |
| [ml] | [mS/cm] | [mS/cm] | [mS/cm] | [mS/cm] |
| 0.0 | 3.39 | 1.77 | 1.18 | 2.39 |
| 0.5 | 5.38 | 3.15 | 2.48 | 4.68 |
| 1.0 | 7.17 | 4.65 | 4.12 | 6.52 |
| 1.5 | 8.74 | 6.16 | 5.63 | 8.39 |
| 2.0 | 10.05 | 7.44 | 6.94 | 9.74 |
| 2.5 | 11.19 | 8.67 | 8.16 | 10.93 |
| 3.0 | 12.01 | 9.61 | 9.22 | 11.76 |
| 3.5 | 12.85 | 10.49 | 10.07 | 12.51 |
| 4.0 | 13.36 | 11.12 | 10.83 | 12.97 |
| 4.5 | 13.75 | 11.69 | 11.40 | 13.42 |
| 5.0 | 14.06 | 12.17 | 11.87 | 13.64 |
| 5.5 | 14.30 | 12.53 | 12.24 | 13.86 |
| 6.0 | 14.44 | 12.80 | 12.46 | 13.97 |
| 6.5 | 14.53 | 13.03 | 12.63 | 14.00 |
| 7.0 | 14.63 | 13.19 | 12.77 | 13.97 |
| 7.5 | 14.63 | 13.30 | 12.86 | 13.93 |
| 8.0 | 14.60 | 13.33 | 12.91 | 13.87 |
| 8.5 | 14.53 | 13.36 | 12.96 | 13.83 |
| 9.0 | 14.47 | 13.36 | 12.91 | 13.75 |
| 9.5 | 14.39 | 13.36 | 12.88 | 13.64 |
| 10.0 | 14.30 | 13.33 | 12.83 | 13.53 |
| 10.5 | 14.20 | 13.28 | 12.74 | 13.42 |
| 11.0 | 14.08 | 13.19 | 12.63 | 13.29 |
| 11.5 | 13.97 | 13.13 | 12.57 | |
| 12.0 | 13.84 | 13.08 | 12.52 | |
| 12.5 | 13.72 | 13.00 | 12.51 | |
| 13.0 | | | | |
| 13.5 | | | | |

Table for FIG. 14: Conductivities of different IL-containing
compositions on addition of the amount specified in each
case of the solvent specified to 5 ml of the starting sample
(IL plus conductive salt as specified).

| | σ(Et3STFSI/ | σ(Et3STFSI/ | | σ(Py14TFSI/ |
|---|---|---|---|---|
| | LiTFSI | LiTFSI | σ(Py14 | LiTFSI |
| Solvent | (0.50 | (0.50 | TFSI/LiTFSI | 0.50 |
| added | M)/GBL) | M)/EC_DMC) | 0.5 M/GBL) | M/EC_DMC) |
| [ml] | [mS/cm] | [mS/cm] | [mS/cm] | [mS/cm] |
| 0.0 | 3.25 | 3.34 | 1.12 | 1.18 |
| 0.5 | 5.33 | 5.25 | 2.59 | 2.48 |
| 1.0 | 6.77 | 7.25 | 3.93 | 4.12 |
| 1.5 | 8.48 | 9.05 | 5.54 | 5.63 |
| 2.0 | 9.94 | 10.53 | 6.79 | 6.94 |
| 2.5 | 11.26 | 11.75 | 8.06 | 8.16 |
| 3.0 | 12.29 | 12.77 | 9.08 | 9.22 |
| 3.5 | 13.08 | 13.69 | 9.91 | 10.07 |
| 4.0 | 13.69 | 14.33 | 10.52 | 10.83 |
| 4.5 | 14.21 | 14.83 | 11.11 | 11.40 |
| 5.0 | 14.59 | 15.25 | 11.60 | 11.87 |
| 5.5 | 14.82 | 15.54 | 11.90 | 12.24 |
| 6.0 | 15.06 | 15.77 | 12.16 | 12.46 |
| 6.5 | 15.20 | 15.90 | 12.35 | 12.63 |
| 7.0 | 15.26 | 16.01 | 12.45 | 12.77 |
| 7.5 | 15.33 | 16.04 | 12.54 | 12.86 |
| 8.0 | 15.37 | 16.01 | 12.54 | 12.91 |
| 8.5 | 15.32 | 15.98 | 12.57 | 12.96 |
| 9.0 | 15.26 | 15.93 | 12.57 | 12.91 |
| 9.5 | 15.20 | 15.87 | 12.54 | 12.88 |
| 10.0 | 15.09 | 15.77 | 12.52 | 12.83 |
| 10.5 | 15.01 | 15.68 | 12.46 | 12.74 |
| 11.0 | 14.89 | 15.54 | 12.40 | 12.63 |
| 11.5 | 14.78 | 15.37 | 12.35 | 12.57 |
| 12.0 | 14.64 | 15.26 | 12.28 | 12.52 |
| 12.5 | 14.47 | 15.12 | 12.16 | 12.51 |
| 13.0 | 14.36 | 15.01 | | |
| 13.5 | 14.25 | 14.86 | | |

Table for FIG. 15: Conductivities of different IL-containing compositions
on addition of the amount specified in each case of the solvent specified
to 5 ml of the starting sample (IL plus conductive salt as specified).

| | σ(Et3STFSI/LiTFSI | σ(Et3STFSI/LiTFSI | σ(Et3STFSI/LiTFSI | σ((MeOE)MPyr |
|---|---|---|---|---|
| | (0.50 | (0.50 | (0.50 | TFSI/LiTFSI 0.5 |
| | M)/EC_DMC | M)/EC_DMC | M)/EC_DMC | M/EC_DMC |
| Solvent added | 75_25) | 70_30) | 66_33) | 70_30) |
| [ml] | [mS/cm] | [mS/cm] | [mS/cm] | [mS/cm] |
| 0.0 | 3.36 | 3.25 | 3.32 | 1.18 |
| 0.5 | 5.53 | 5.33 | 5.42 | 2.48 |
| 1.0 | 7.31 | 6.77 | 7.38 | 4.12 |
| 1.5 | 9.23 | 8.48 | 9.31 | 5.63 |
| 2.0 | 10.64 | 9.94 | 10.82 | 6.94 |
| 2.5 | 11.87 | 11.26 | 12.07 | 8.16 |
| 3.0 | 12.85 | 12.29 | 13.10 | 9.22 |
| 3.5 | 13.64 | 13.08 | 14.03 | 10.07 |
| 4.0 | 14.25 | 13.69 | 14.60 | 10.83 |
| 4.5 | 14.69 | 14.21 | 15.12 | 11.40 |
| 5.0 | 15.03 | 14.59 | 15.53 | 11.87 |
| 5.5 | 15.26 | 14.82 | 15.77 | 12.24 |
| 6.0 | 15.45 | 15.06 | 15.98 | 12.46 |
| 6.5 | 15.56 | 15.20 | 16.10 | 12.63 |
| 7.0 | 15.65 | 15.26 | 16.20 | 12.77 |
| 7.5 | 15.65 | 15.33 | 16.26 | 12.86 |
| 8.0 | 15.65 | 15.37 | 16.23 | 12.91 |
| 8.5 | 15.58 | 15.32 | 16.20 | 12.96 |
| 9.0 | 15.55 | 15.26 | 16.12 | 12.91 |
| 9.5 | 15.42 | 15.20 | 16.07 | 12.88 |
| 10.0 | 15.32 | 15.09 | 15.93 | 12.83 |
| 10.5 | 15.23 | 15.01 | 15.77 | 12.74 |
| 11.0 | 15.09 | 14.89 | 15.65 | 12.63 |
| 11.5 | 14.97 | 14.78 | 15.54 | 12.57 |
| 12.0 | 14.82 | 14.64 | 15.41 | 12.52 |
| 12.5 | 14.67 | 14.47 | 15.29 | 12.51 |
| 13.0 | 14.53 | 14.36 | 15.12 | |
| 13.5 | 14.39 | 14.25 | 14.98 | |

Table for FIG. 16: Conductivities of different IL-containing compositions on addition of
the amount specified in each case of the solvent specified to 5 ml of the starting sample
(IL plus conductive salt as specified).

| | | | | | | σ((MeOE) | σ((MeOE) |
|---|---|---|---|---|---|---|---|
| | | | | | | MPyr | MPyr |
| | σ(Py14OTf/ | σ(Py14TFSI/ | σ(Py14TFSI/ | σ(Py14TFSI/ | σ(Et3STFSI/ | TFSI/LiTFSI | TFSI/LiTFSI |
| | LiBOB | LiTFSI | LiTFSI | LiOTf | LiTFSI | 0.5 | 0.5 |
| Solvent | 0.5 | (0.50 M)/ | 0.50 | 0.50 | (0.50 | M/EC_DMC | M/EC_DMC |
| added | M/EC_DMC) | DME) | M/EC_DMC) | M/EC_DMC) | M)/EC_DMC) | 70_30) | 70_30) |
| [ml] | [mS/cm] | [mS/cm] | [mS/cm] | [mS/cm] | [mS/cm] | [mS/cm] | [mS/cm] |
| 0.0 | 1.63 | 1.12 | 1.18 | 1.68 | 3.25 | 1.18 | 1.18 |
| 0.5 | 2.32 | 2.63 | 2.48 | 2.76 | 5.33 | 2.48 | 2.48 |
| 1.0 | 3.60 | 4.05 | 4.12 | 3.78 | 6.77 | 4.12 | 4.12 |
| 1.5 | 4.96 | 5.71 | 5.63 | 5.20 | 8.48 | 5.63 | 5.63 |
| 2.0 | 6.23 | 7.24 | 6.94 | 6.39 | 9.94 | 6.94 | 6.94 |
| 2.5 | 7.39 | 8.72 | 8.16 | 7.56 | 11.26 | 8.16 | 8.16 |
| 3.0 | 8.39 | 10.05 | 9.22 | 8.49 | 12.29 | 9.22 | 9.22 |
| 3.5 | 9.16 | 11.23 | 10.07 | 9.39 | 13.08 | 10.07 | 10.07 |
| 4.0 | 9.84 | 12.18 | 10.83 | 10.10 | 13.69 | 10.83 | 10.83 |
| 4.5 | 10.34 | 12.97 | 11.40 | 10.72 | 14.21 | 11.40 | 11.40 |
| 5.0 | 10.83 | 13.61 | 11.87 | 11.20 | 14.59 | 11.87 | 11.87 |
| 5.5 | 11.18 | 14.08 | 12.24 | 11.60 | 14.82 | 12.24 | 12.24 |
| 6.0 | 11.45 | 14.42 | 12.46 | 11.84 | 15.06 | 12.46 | 12.46 |
| 6.5 | 11.68 | 14.69 | 12.63 | 12.07 | 15.20 | 12.63 | 12.63 |
| 7.0 | 11.84 | 14.86 | 12.77 | 12.28 | 15.26 | 12.77 | 12.77 |
| 7.5 | 11.96 | 14.99 | 12.86 | 12.43 | 15.33 | 12.86 | 12.86 |
| 8.0 | 12.07 | 15.09 | 12.91 | 12.54 | 15.37 | 12.91 | 12.91 |
| 8.5 | 12.07 | 15.06 | 12.96 | 12.57 | 15.32 | 12.96 | 12.96 |
| 9.0 | 12.07 | 15.03 | 12.91 | 12.62 | 15.26 | 12.91 | 12.91 |
| 9.5 | 12.06 | 14.98 | 12.88 | 12.60 | 15.20 | 12.88 | 12.88 |
| 10.0 | 12.06 | 14.89 | 12.83 | 12.60 | 15.09 | 12.83 | 12.83 |
| 10.5 | 11.98 | 14.80 | 12.74 | 12.57 | 15.01 | 12.74 | 12.74 |
| 11.0 | 11.95 | 14.63 | 12.63 | 12.54 | 14.89 | 12.63 | 12.63 |
| 11.5 | 11.91 | 14.50 | 12.57 | 12.52 | 14.78 | 12.57 | 12.57 |
| 12.0 | 11.84 | 14.30 | 12.52 | 12.46 | 14.64 | 12.52 | 12.52 |
| 12.5 | 11.72 | 14.14 | 12.51 | 12.40 | 14.47 | 12.51 | 12.51 |
| 13.0 | 11.62 | 14.00 | | 12.35 | 14.36 | | |
| 13.5 | 11.51 | 13.80 | | 12.24 | 14.25 | | |

1. An electrolyte formulation comprising:
a) an ionic liquid which is electrochemically stable over a range of at least 4.5 V, has a viscosity of less than 300 mP·s at 20° C. and has a conductivity of at least 1 mS/cm at 20° C., and
b) an aprotic, dipolar solvent in an amount of 20 to 60% by volume based on the electrolyte formulation,
wherein the conductivity of the electrolyte formulation is greater at least by a factor of 2 than the conductivity of the ionic liquid.

2. The formulation according to claim 1, wherein the ionic liquid comprises an organic cation selected from the group consisting of alkylammonium, pyridinium, pyrazolium, pyrrolium, pyrrolinium, piperidinium, pyrrolidinium, imidazolium and sulphonium compounds.

3. The formulation according to claim 2, wherein the organic cation is a tetraalkylammonium compound, a 1,1-dialkylpyrrolidinium compound, a 1,2,3-trialkylimidazolium compound or a trialkylsulphonium compound.

4. The formulation according to claim 3, wherein the alkyl radicals are each independently selected from the group consisting of:
a) aliphatic straight-chain or branched hydrocarbon radicals which has 1-20 carbon atoms and optionally have, in the carbon chain, heteroatoms selected from the group consisting of N, S and O, and also unsaturations in the form of one or more double or triple bonds and optionally one or more functional groups which are selected from the group consisting of amino, carboxyl, acyl, and hydroxyl groups; and b) cycloaliphatic hydrocarbon radicals having 3 to 20 carbon atoms, where the cyclic radicals optionally have ring heteroatoms selected from the group consisting of N, S and O and unsaturations in the form of one or more double or triple bonds and optionally one or more functional groups which are selected from the group consisting of amino, carboxyl, acyl, and hydroxyl groups.

5. The formulation according to claim 1, wherein the ionic liquid comprises an anion selected from the group consisting of hydrogendifluoride, TFSI, FSI, trifluoromethanesulphonate (triflate), dicyanamide, thiocyanate, methide, PF₆, trifluoroacetate, perfluorobutanesulphonate (nonaflate) and tetrafluoroborate.

6. The formulation according to claim 1, wherein the ionic liquid comprises a sulphonium cation.

7. The formulation according to claim 1, wherein the ionic liquid is selected from the group consisting of [Et₃S][TFSI], [Py₁₄][TFSI], [Py₁₄][OTf], [BMIM][OTf], [EdiMIM][TFSI], [EMIM][TFSI], [EMIM][BF₄], [(MeOE)MePyrr][OTf], [(MeOE)MePyrr][nonaflate], [(MeOE)MePyrr][TFSI], [(MeOE)MIM][OTf], [(MeOE)MiM][nonaflate], [(MeOE)MIM][TFSI], [(MeOE)DiMIM][OTf], [(MeOE)DiMIM][nonaflate]and [(MeOE)DiMIM][TFSI].

8. The formulation according to claim 1, wherein the aprotic dipolar solvent is ethylene carbonate, propylene carbonate, dimethyl carbonate, dimethyl sulphoxide, acetone, acetonitrile, dimethylformamide, y-butyrolactone, dimethoxyethane, tetrahydrofuran, a dialkyl carbonate, a carboxylic ester or mixtures thereof.

9. The formulation according to claim 8, wherein the solvent is a mixture of ethylene carbonate and dimethyl carbonate.

10. The formulation according to claim 1, wherein the formulation further comprises an additive with a polymerizable functional group.

11. The formulation according to claim 1, wherein the additive is selected from the group consisting of acrylonitrile, ethylene sulphite, propanesultone, an organic carbonate, and mixtures thereof.

12. The formulation according to claim 1, wherein the formulation has a flashpoint of more than 150° C.

13. The formulation according to claim 1, wherein the formulation further comprises a conductive salt which is selected from the group consisting of LiBOB, LiTFSI, LiFSI, LiClO₄, LiBF₄, LiOTf and LiPF₆.

14. The formulation according to claim 1, wherein the ionic liquid is a 1-alkoxyalkyl-1-alkylpyrrolidinium compound, and the formulation does not contain a conductive salt.

15. The formulation according to claim 1, wherein the ionic liquid is a triflate compound, and the formulation comprises LiBOB, LiTFSI or lithium triflate as a conductive salt.

16. The formulation according to claim 1, wherein the ionic liquid is [Py₁₄][TFSI]or [(MeOE)MPyrr][TFSI], and the formulation comprises LiTFSI or LiOTf as a conductive salt.

17. The formulation according to claim 16, wherein the formulation comprises LiTFSI as a conductive salt in a concentration of less than 0.75 mol/l based on the ionic liquid.

18. The formulation according to claim 1, wherein the ionic liquid comprises a pyrrolidinium compound, and the formulation comprises DMC, DME or EC/DMC, as a solvent.

19. The formulation according to claim 1, wherein the ionic liquid is [Py₁₄][OTf]and the formulation comprises at least 25% by volume as a solvent.

20. The formulation according to claim 1, wherein the ionic liquid is a sulphonium compound, and the formulation comprises DMC, DME or EC/DMC as a solvent.

21. The formulation according to claim 20, wherein the ionic liquid is [Et₃S][TFSI], and the formulation comprises EC/DMC, as a solvent, and LiTFSI as a conductive salt in a concentration of less than 0.75 mol/l based on the ionic liquid.

22. An electrical energy storage system comprising the electrolyte formulation according to claim 1.
